(19) United States
(12) Patent Application Publication
(10) Pub. No.: US 2025/0028311 A1
(43) Pub. Date: Jan. 23, 2025

(54) DETECTING ANOMALIES AND PREDICTING FAILURES IN PETROLEUM-INDUSTRY OPERATIONS

(71) Applicant: Schlumberger Technology Corporation, Sugar Land, TX (US)

(72) Inventors: Praprut Songchitruksa, Houston, TX (US); Sreekrishnan Ramachandran, Houston, TX (US); Luciana Velasco Medani, Rio de Janeiro (BR)

(21) Appl. No.: 18/775,581

(22) Filed: Jul. 17, 2024

Related U.S. Application Data
(60) Provisional application No. 63/514,179, filed on Jul. 18, 2023.

(51) Int. Cl. G05B 23/02; G05B 13/02

(52) U.S. Cl. CPC G05B 23/024; G05B 13/0265; G05B 2223/02

(57) ABSTRACT

Systems and methods for detecting anomalies and predicting failures in petroleum-industry operations, using Machine Learning. Systems and methods are provided for determining system anomalies and individual resource anomalies using trained models and predicting estimated system times to failure based thereon. Features correlated to system failures may be identified in a root cause analysis and used to perform forecasting to determine when a failure is likely to occur. The forecasting may include determining when one or more components may likely meet certain thresholds associated with failures of the components. A protective action may be performed to protect resources associated with the operations, based on determining the length of time until system failure of the operation is estimated to occur.

### CROSS REFERENCE TO RELATED APPLICATIONS

The present application claims priority to and the benefit of U.S. Provisional patent application Ser. No. 63/514,179 titled “PREDICTIVE HEALTH MONITORING SYSTEM FOR PROCESS EQUIPMENT” filed Jul. 18, 2023, the disclosure of which is incorporated herein by reference in its entirety.

### BACKGROUND OF THE DISCLOSURE

Wellbores may be drilled into a surface location or seabed for a variety of exploratory or extraction purposes. For example, a wellbore may be drilled to access fluids, such as liquid and gaseous hydrocarbons, stored in subterranean formations and to extract the fluids from the formations. Wellbores used to produce or extract fluids may be formed in earthen formations using earth-boring tools such as drill bits for drilling wellbores and reamers for enlarging the diameters of wellbores.

Equipment failures and downtime can be costly in the petroleum industry, and especially when drilling a well. For example, if a drill bit fails, the drilling operation may be shut down while the failed drill bit is replaced. This may entail removing the drillstring from the borehole to replace the failed drill bit on the drillstring and inserting the drillstring back down the borehole. Removing and inserting the drillstring may take a large amount of time and be hard to do, especially if the borehole is long. The ability to automatically assess the condition of equipment, identify potential contributing factors, predict potential trips/failures, and optimize maintenance strategies to minimize downtime can help maximize operational efficiencies. Many existing prognostic health monitoring solutions are driven by subject matter experts and are equipment specific. This makes it difficult for the system to scale with complex and diverse equipment.

### SUMMARY

In some embodiments, a computer-implemented method may be provided for protecting resources associated with petroleum-industry operations. At least a portion of the method may be performed by a computing device that includes at least one processor. The method may include constructing an anomaly detection model, which may include obtaining a feature set associated with failures of petroleum-industry operations; determining, using unsupervised clustering or deep learning, system anomalies, corresponding to the feature set, with an increased correlation to system failures of the petroleum-industry operations; and applying fault mode analysis to the system anomalies.

In some embodiments, a computer-implemented method may be provided for protecting resources associated with petroleum-industry operations. At least a portion of the method may be performed by a computing device that includes at least one processor. The method may include monitoring data received from resources associated with a petroleum-industry operation; detecting a system anomaly with an increased correlation to a system failure, based on the monitored data, using machine learning; and performing a protective action to protect the resources associated with the petroleum-industry operation, based on detecting the system anomaly.

In some embodiments, a computer-implemented method may be provided for protecting resources associated with petroleum-industry operations. At least a portion of the method may be performed by a computing device that includes at least one processor. The method may include monitoring data received from a plurality of resources associated with a petroleum-industry operation; detecting a system anomaly associated with the petroleum-industry operation based on the monitored data; determining a subset of the plurality of resources that correlate to the system anomaly; determining, for each of one or more resources of the subset of the plurality of resources, an estimated time to failure associated with the resource; determining a length of time until system failure of the petroleum-industry operation is estimated to occur, based on the estimated times to failure associated with the one or more resources; and performing a protective action to protect the plurality of resources associated with the petroleum-industry operation, based on determining the length of time until system failure of the petroleum-industry operation is estimated to occur.

This summary is provided to introduce a selection of concepts that are further described below in the detailed description. This summary is not intended to identify key or essential features of the claimed subject matter, nor is it intended to be used as an aid in limiting the scope of the claimed subject matter. Additional features and advantages of embodiments of the disclosure will be set forth in the description which follows, and in part will be obvious from the description, or may be learned by the practice of such embodiments.

### BRIEF DESCRIPTION OF THE DRAWINGS

In order to describe the manner in which the above-recited and other features of the disclosure can be obtained, a more particular description will be rendered by reference to specific implementations thereof which are illustrated in the appended drawings. For better understanding, the like elements have been designated by like reference numbers throughout the various accompanying figures. While some of the drawings may be schematic or exaggerated representations of concepts, at least some of the drawings may be drawn to scale. Understanding that the drawings depict some example implementations, the implementations will be described and explained with additional specificity and detail using the accompanying drawings in which:

FIG. 1 illustrates an example environment in which a system for detecting anomalies and predicting failures in petroleum-industry operations may be implemented, according to at least one embodiment of the present disclosure;

FIG. 2 shows an example of a wellsite system in which a system for detecting anomalies and predicting failures in petroleum-industry operations may be implemented, according to at least one embodiment of the present disclosure.

FIG. 3 illustrates a schematic view of a computing or processor system that may be implemented in a system for detecting anomalies and predicting failures in petroleum-industry operations, according to at least one embodiment of the present disclosure.

FIG. 4 illustrates a flowchart illustrating a computer-implemented method that supports detecting anomalies and predicting failures in petroleum-industry operations, according to some implementations.

FIG. 5 illustrates an example implementation of a system for detecting anomalies and predicting failures in petroleum-industry operations, according to at least one embodiment of the present disclosure.

FIG. 6 illustrates an example block diagram of training an anomaly identification machine learning model to detect anomalies and predict failures in petroleum-industry operations, according to at least one embodiment of the present disclosure.

FIG. 7 shows a flowchart illustrating a computer-implemented method that supports detecting anomalies and predicting failures in petroleum-industry operations according to some implementations.

FIG. 8 shows a flowchart illustrating a computer-implemented method that supports detecting anomalies and predicting failures in petroleum-industry operations according to some implementations.

FIG. 9 shows a flowchart illustrating a computer-implemented method that supports detecting anomalies and predicting failures in petroleum-industry operations according to some implementations.

FIG. 10 shows a flowchart illustrating a computer-implemented method that supports detecting anomalies and predicting failures in petroleum-industry operations according to some implementations.

FIGS. 11A and 11B reflect results obtained using an example implementation of an anomaly detection and failure prediction system on a compressor.

FIGS. 12A and 12B reflect results obtained using an example implementation of an anomaly detection and failure prediction system on a turbine.

FIGS. 13A and 13B reflect results obtained using an example implementation of an anomaly detection and failure prediction system on a gas dehydrator.

### DETAILED DESCRIPTION

This disclosure generally relates to detecting anomalies and predicting failures in petroleum-industry operations. In particular, systems and methods are provided for determining system anomalies and individual resource anomalies using trained models and predicting estimated system times to failure based thereon.

Equipment failures and downtime can be costly in the petroleum industry. For example, if a drill bit fails while drilling a well, the drilling operation may be shut down while the failed drill bit is replaced. This may entail removing the drillstring from the borehole to replace the failed drill bit on the drillstring and then inserting the drillstring back down the borehole with the new drill bit. Removing and inserting the drillstring may take a large amount of time and be hard to do, especially if the borehole is long.

Many existing prognostic health monitoring solutions are driven by subject matter experts and are equipment specific. This makes it difficult for the system to scale with complex and diverse equipment.

Solutions presented herein may be automated, data-driven, and equipment agnostic. The solutions may be immediately scalable as more equipment comes online, may require little manual configuration, and may include compute infrastructure that can scale up and down automatically with the computing demand to make it more cost effective. The ability to automatically assess the condition of equipment, identify potential contributing factors, predict potential trips/failures, and optimize maintenance strategies to minimize downtime can help maximize operational efficiencies.

In some embodiments, anomalies in petroleum-industry equipment may be timely and proactively identified, which may help reduce the possibility of equipment failure and/or shutdown, production deferment, and expensive repairs. Root cause factors may also be identified that contribute to the anomalies and help the operators pinpoint the source of problems.

In some embodiments, predictive maintenance may be provided. Features correlated to system failures may be identified in a root cause analysis and used to perform forecasting to determine when a failure is likely to occur. For example, the forecasting may include determining when one or more components may likely meet certain thresholds associated with failures of the components. In this way, predictive capabilities beyond problem detection may be provided by embodiments discussed herein. The forecasting horizon may depend on failure records and data availability may be improved over time, e.g., using machine learning.

As will be discussed in further detail below, the present disclosure includes a number of practical applications having features described herein that provide benefits and/or solve problems associated with the petroleum industry. Some example benefits are discussed herein in connection with various features and functionalities provided by a system anomaly detection system implemented on one or more computing devices. It will be appreciated that benefits explicitly discussed in connection with one or more embodiments described herein are provided by way of example and are not intended to be an exhaustive list of all possible benefits of the system anomaly detection system.

For example, the system may be automated, data-driven, and equipment agnostic. The system may be scalable as more equipment comes online, may require little manual configuration, and may include compute infrastructure that may scale up and down automatically with the computing demand to make it more cost effective.

In some examples, a machine learning pipeline may be used where ML models may be configured and updated for their tasks when there are changes/additions to the input datasets. In this way, the model may be automatically retrained and upgraded when retraining conditions are met. In some examples, the system may provide automated model building with feature engineering. The pipeline may be configured to automate the model building process where the most suitable model may be tuned and deployed within the pipeline.

The model builder may include feature engineering steps where algorithms compute features over time and frequency domains for the model development. Subject matter experts may provide additional input features to incorporate into the models to improve performance. These optional input features may be provided when, for example, customization for specific equipment may be beneficial and/or when data availability may be limited.

Additionally, a system may be implemented as a novel, data-driven predictive health monitoring solution that may detect system anomalies, provide anomaly interpretation, and forecast time to failure on certain anomalies. Among other benefits, this may allow protective actions to be performed to protect against system failures.

As used herein, a “time to failure” refers to a length of time remaining until failure is likely to occur. The length of time assumes continuous usage. For example, a time to failure associated with a system (may also be referred to herein as a “system time to failure”) is the length of time, assuming continuous usage, until the system is likely to fail. Similarly, a time to failure associated with an individual resource (may also be referred to herein as an “individual time to failure”) is the length of time, assuming continuous usage, until the resource is likely to fail. Times to failure may be measured in any time units desired. For example, times to failure may be measured in minutes, hours, days, weeks, months or years, or any combination thereof, depending on context.

As used herein, “petroleum-industry operations” and the like refer to operations that may be performed in the petroleum industry. Some examples may include operations associated with exploration, extraction, refining, and transportation of petroleum products. By way of example and not limitation, drilling wells, transporting oil to refineries, and converting crude oil into petroleum products, may each include or be petroleum-industry operations.

As used herein, “resources” associated with petroleum-industry operations refer to devices, assemblies, systems, and the like, that may be used in performing the operations. By way of example and not limitation, resources associated with a drilling operation may include, among other things, a drill rig, drill pipes, drilling tool assemblies, drill bits, drilling fluid, sensors, etc.

As used herein with respect to petroleum-industry operations, “anomalies” and the like are deviations from normal operations and are context dependent. For example, an anomaly associated with a system (may be referred to herein as a “system anomaly”) corresponds to a deviation from normal system operations and an anomaly associated with a resource (may be referred to herein as an “individual anomaly”) corresponds to a deviation from normal operations associated with the resource.

The term “machine-learning model” refers to a computer model or computer representation that may be trained (e.g., optimized) based on inputs to approximate unknown functions. For instance, a machine-learning model may include, but is not limited to, a neural network (e.g., a convolutional neural network (CNN), LSTM, graph neural network, or deep learning model), a decision tree (e.g., a gradient-boosted decision tree), a linear regression model, a logistic regression model, Dirichlet allocation (LDA) model, multi-arm bandit model, random forest model, support vector machine (SVM) model, or a combination of these models.

Additional details will now be provided regarding systems described herein in relation to illustrative figures portraying example implementations.

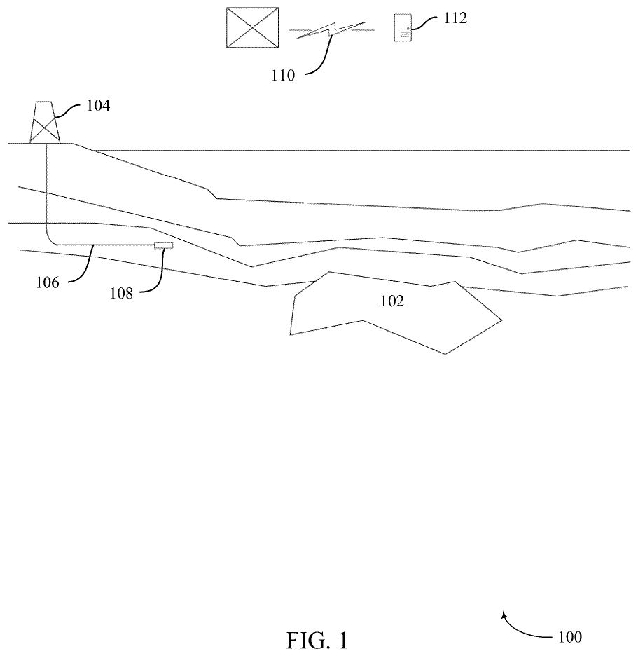

FIG. 1 illustrates an example environment 100 in which a system for detecting anomalies and predicting failures in petroleum-industry operations may be implemented in accordance with one or more embodiments described herein. The environment may include a reservoir 102 and various geological features, such as stratified layers. The geological aspects of the environment 100 may contain other features such as faults, basins, and others. The reservoir 102 may be located on land or offshore.

The environment 100 may be outfitted with sensors, detectors, actuators, etc. to be used in connection with the drilling process. FIG. 1 illustrates equipment 104 associated with a well 106 being constructed using downhole equipment 108. The downhole equipment 108 may be, for example, part of a bottom hole assembly (BHA). The BHA may be used to drill the well 106. The downhole equipment 108 may communicate information to the equipment 104 at the surface and may receive instructions and information from the surface equipment 104 as well. The surface equipment 104 and the downhole equipment 108 may communicate using various communications techniques, such as mud-pulse telemetry, electromagnetic (EM) telemetry, or others depending on the equipment and technology in use for the drilling operation.

The surface equipment 104 may also include communications means to communicate over a network 110 to remote computing devices 112. For example, the surface equipment 104 may communicate data using a satellite network to computing devices 112 supporting a remote team monitoring and assisting in the creation of the well 106 and other wells in other locations. Depending on the communications infrastructure available at the wellsite, various communications equipment and techniques (cellular, satellite, wired Internet connection, etc.) may be used to communicate data from the surface equipment 104 to the remote computing devices 112. In some embodiments, the surface equipment 104 sends data from measurements taken at the surface and measurements taken downhole by the downhole equipment 108 to the remote computing devices 112.

During the well construction process, a variety of operations (such as cementing, wireline evaluation, testing, etc.) may also be conducted. In such embodiments, the data collected by tools and sensors and used for reasons such as reservoir characterization may also be collected and transmitted by the surface equipment 104.

In FIG. 1, the well 106 includes a substantially horizontal portion (e.g., lateral portion) that may intersect with one or more fractures. For example, a well in a shale formation may pass through natural fractures, artificial fractures (e.g., hydraulic fractures), or a combination thereof. Such a well may be constructed using directional drilling techniques as described herein. However, these same techniques may be used in connection with other types of directional wells (such as slant wells, S-shaped wells, deep inclined wells, and others) and are not limited to horizontal wells.

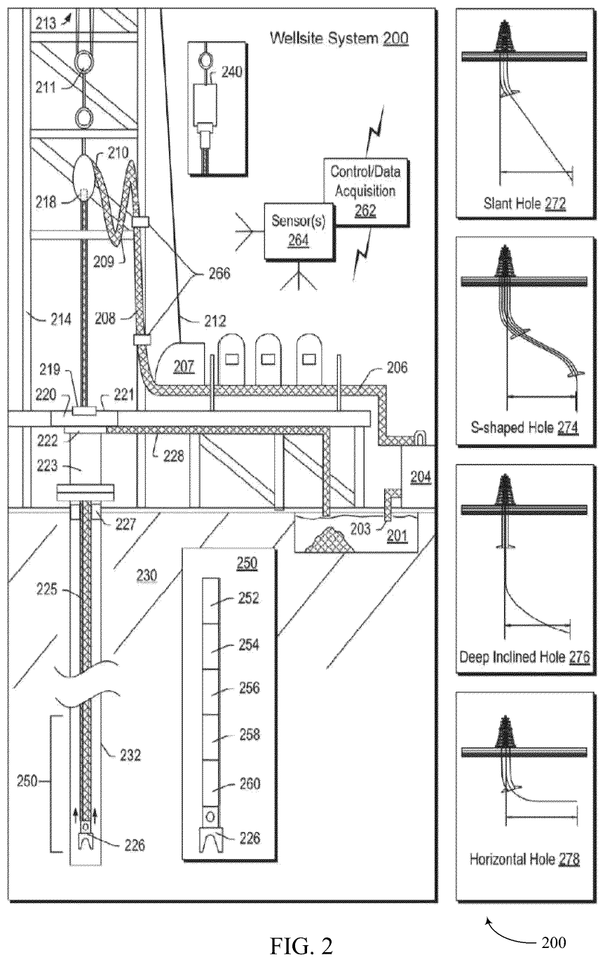

FIG. 2 shows an example of a wellsite system 200 (e.g., at a wellsite that may be onshore or offshore) in which a system for detecting anomalies and predicting failures in petroleum-industry operations may be implemented according to at least one embodiment of the present disclosure. As shown, the wellsite system 200 can include a mud tank 201 for holding mud and other material (e.g., where mud can be a drilling fluid), a suction line 203 that serves as an inlet to a mud pump 204 for pumping mud from the mud tank 201 such that mud flows to a vibrating hose 206, a drawworks 207 for winching drill line or drill lines 212, a standpipe 208 that receives mud from the vibrating hose 206, a kelly hose 209 that receives mud from the standpipe 208, a gooseneck or goosenecks 210, a traveling block 211, a crown block 213 for carrying the traveling block 211 via the drill line or drill lines 212, a derrick 214, a kelly 218 or a top drive 240, a kelly drive bushing 219, a rotary table 220, a drill floor 221, a bell nipple 222, one or more blowout preventors (BOPs) 223, a drillstring 225, a drill bit 226, a casing head 227 and a flow pipe 228 that carries mud and other material to, for example, the mud tank 201.

In the example system of FIG. 2, a borehole 232 is formed in subsurface formations 230 by rotary drilling; noting that various example embodiments may also use one or more directional drilling techniques, equipment, etc.

As shown in the example of FIG. 2, the drillstring 225 is suspended within the borehole 232 and has a drillstring assembly 250 that includes the drill bit 226 at its lower end. As an example, the drillstring assembly 250 may be a bottom hole assembly (BHA).

The wellsite system 200 can provide for operation of the drillstring 225 and other operations. As shown, the wellsite system 200 includes the traveling block 211 and the derrick 214 positioned over the borehole 232. As mentioned, the wellsite system 200 can include the rotary table 220 where the drillstring 225 pass through an opening in the rotary table 220.

As shown in the example of FIG. 2, the wellsite system 200 can include the kelly 218 and associated components, etc., or a top drive 240 and associated components. As to a kelly example, the kelly 218 may be a square or hexagonal metal/alloy bar with a hole drilled therein that serves as a mud flow path. The kelly 218 can be used to transmit rotary motion from the rotary table 220 via the kelly drive bushing 219 to the drillstring 225, while allowing the drillstring 225 to be lowered or raised during rotation. The kelly 218 can pass through the kelly drive bushing 219, which can be driven by the rotary table 220. As an example, the rotary table 220 can include a master bushing that operatively couples to the kelly drive bushing 219 such that rotation of the rotary table 220 can turn the kelly drive bushing 219 and hence the kelly 218. The kelly drive bushing 219 can include an inside profile matching an outside profile (e.g., square, hexagonal, etc.) of the kelly 218; however, with slightly larger dimensions so that the kelly 218 can freely move up and down inside the kelly drive bushing 219.

As to a top drive example, the top drive 240 can provide functions performed by a kelly and a rotary table. The top drive 240 can turn the drillstring 225. As an example, the top drive 240 can include one or more motors (e.g., electric and/or hydraulic) connected with appropriate gearing to a short section of pipe called a quill, that in turn may be screwed into a saver sub or the drillstring 225 itself. The top drive 240 can be suspended from the traveling block 211, so the rotary mechanism is free to travel up and down the derrick 214. As an example, a top drive 240 may allow for drilling to be performed with more joint stands than a kelly/rotary table approach.

In the example of FIG. 2, the mud tank 201 can hold mud, which can be one or more types of drilling fluids. As an example, a wellbore may be drilled to produce fluid, inject fluid or both (e.g., hydrocarbons, minerals, water, etc.).

In the example of FIG. 2, the drillstring 225 (e.g., including one or more downhole tools) may be composed of a series of pipes threadably connected to form a long tube with the drill bit 226 at the lower end thereof. As the drillstring 225 is advanced into a wellbore for drilling, at some point in time prior to or coincident with drilling, the mud may be pumped by the pump 204 from the mud tank 201 (e.g., or other source) via the lines 206, 208 and 209 to a port of the kelly 218 or, for example, to a port of the top drive 240. The mud can then flow via a passage (e.g., or passages) in the drillstring 225 and out of ports located on the drill bit 226 (see, e.g., a directional arrow). As the mud exits the drillstring 225 via ports in the drill bit 226, it can then circulate upwardly through an annular region between an outer surface(s) of the drillstring 225 and surrounding wall(s) (e.g., open borehole, casing, etc.), as indicated by directional arrows. In such a manner, the mud lubricates the drill bit 226 and carries heat energy (e.g., frictional or other energy) and formation cuttings to the surface where the mud (e.g., and cuttings) may be returned to the mud tank 201, for example, for recirculation (e.g., with processing to remove cuttings, etc.).

The mud pumped by the pump 204 into the drillstring 225 may, after exiting the drillstring 225, form a mudcake that lines the wellbore which, among other functions, may reduce friction between the drillstring 225 and surrounding wall(s) (e.g., borehole, casing, etc.). A reduction in friction may facilitate advancing or retracting the drillstring 225. During a drilling operation, the entire drillstring 225 may be pulled from a wellbore and optionally replaced, for example, with a new or sharpened drill bit, a smaller diameter drillstring, etc. As mentioned, the act of pulling a drillstring out of a hole or replacing it in a hole is referred to as tripping. A trip may be referred to as an upward trip or an outward trip or as a downward trip or an inward trip depending on trip direction.

As an example, consider a downward trip where upon arrival of the drill bit 226 of the drillstring 225 at a bottom of a wellbore, pumping of the mud commences to lubricate the drill bit 226 for purposes of drilling to enlarge the wellbore. As mentioned, the mud can be pumped by the pump 204 into a passage of the drillstring 225 and, upon filling of the passage, the mud may be used as a transmission medium to transmit energy, for example, energy that may encode information as in mud-pulse telemetry.

As an example, mud-pulse telemetry equipment may include a downhole device configured to effect changes in pressure in the mud to create an acoustic wave or waves upon which information may modulated. In such an example, information from downhole equipment (e.g., one or more modules of the drillstring 225) may be transmitted uphole to an uphole device, which may relay such information to other equipment for processing, control, etc.

As an example, telemetry equipment may operate via transmission of energy via the drillstring 225 itself. For example, consider a signal generator that imparts coded energy signals to the drillstring 225 and repeaters that may receive such energy and repeat it to further transmit the coded energy signals (e.g., information, etc.).

As an example, the drillstring 225 may be fitted with telemetry equipment 252 that includes a rotatable drive shaft, a turbine impeller mechanically coupled to the drive shaft such that the mud can cause the turbine impeller to rotate, a modulator rotor mechanically coupled to the drive shaft such that rotation of the turbine impeller causes said modulator rotor to rotate, a modulator stator mounted adjacent to or proximate to the modulator rotor such that rotation of the modulator rotor relative to the modulator stator creates pressure pulses in the mud, and a controllable brake for selectively braking rotation of the modulator rotor to modulate pressure pulses. In such example, an alternator may be coupled to the aforementioned drive shaft where the alternator includes at least one stator winding electrically coupled to a control circuit to selectively short the at least one stator winding to electromagnetically brake the alternator and thereby selectively brake rotation of the modulator rotor to modulate the pressure pulses in the mud.

In the example of FIG. 2, an uphole control and/or data acquisition system 262 may include circuitry to sense pressure pulses generated by telemetry equipment 252 and, for example, communicate sensed pressure pulses or information derived therefrom for process, control, etc.

The assembly 250 of the illustrated example includes a logging-while-drilling (LWD) module 254, a measurement-while-drilling (MWD) module 256, an optional module 258, a rotary-steerable system (RSS) and/or motor 260, and the drill bit 226. Such components or modules may be referred to as tools where a drillstring can include a plurality of tools.

As to an RSS, it involves technology utilized for directional drilling. Directional drilling involves drilling into the Earth to form a deviated bore such that the trajectory of the bore is not vertical; rather, the trajectory deviates from vertical along one or more portions of the bore. As an example, consider a target that is located at a lateral distance from a surface location where a rig may be stationed. In such an example, drilling can commence with a vertical portion and then deviate from vertical such that the bore is aimed at the target and, eventually, reaches the target. Directional drilling may be implemented where a target may be inaccessible from a vertical location at the surface of the Earth, where material exists in the Earth that may impede drilling or otherwise be detrimental (e.g., consider a salt dome, etc.), where a formation is laterally extensive (e.g., consider a relatively thin yet laterally extensive reservoir), where multiple bores are to be drilled from a single surface bore, where a relief well is desired, etc.

One approach to directional drilling involves a mud motor; however, a mud motor can present some challenges depending on factors such as rate of penetration (ROP), transferring weight to a bit (e.g., weight on bit, WOB) due to friction, etc. A mud motor can be a positive displacement motor (PDM) that operates to drive a bit (e.g., during directional drilling, etc.). A PDM operates as drilling fluid is pumped through it where the PDM converts hydraulic power of the drilling fluid into mechanical power to cause the bit to rotate.

As an example, a PDM may operate in a combined rotating mode where surface equipment is utilized to rotate a bit of a drillstring (e.g., a rotary table, a top drive, etc.) by rotating the entire drillstring and where drilling fluid is utilized to rotate the bit of the drillstring. In such an example, a surface RPM (SRPM) may be determined by use of the surface equipment and a downhole RPM of the mud motor may be determined using various factors related to flow of drilling fluid, mud motor type, etc. As an example, in the combined rotating mode, bit RPM can be determined or estimated as a sum of the SRPM and the mud motor RPM, assuming the SRPM and the mud motor RPM are in the same direction.

As an example, a PDM mud motor can operate in a so-called sliding mode, when the drillstring is not rotated from the surface. In such an example, a bit RPM can be determined or estimated based on the RPM of the mud motor.

An RSS can drill directionally where there is continuous rotation from surface equipment, which can alleviate the sliding of a steerable motor (e.g., a PDM). An RSS may be deployed when drilling directionally (e.g., deviated, horizontal, or extended-reach wells). An RSS can aim to minimize interaction with a borehole wall, which can help to preserve borehole quality. An RSS can aim to exert a relatively consistent side force akin to stabilizers that rotate with the drillstring or orient the bit in the desired direction while continuously rotating at the same number of rotations per minute as the drillstring.

The LWD module 254 may be housed in a suitable type of drill collar and can contain one or a plurality of selected types of logging tools. It will also be understood that more than one LWD and/or MWD module can be employed, for example, as represented at by the module 256 of the drillstring assembly 250. Where the position of an LWD module is mentioned, as an example, it may refer to a module at the position of the LWD module 254, the module 256, etc. An LWD module can include capabilities for measuring, processing, and storing information, as well as for communicating with the surface equipment. In the illustrated example, the LWD module 254 may include a seismic measuring device.

The MWD module 256 may be housed in a suitable type of drill collar and can contain one or more devices for measuring characteristics of the drillstring 225 and the drill bit 226. As an example, the MWD module 256 may include equipment for generating electrical power, for example, to power various components of the drillstring 225. As an example, the MWD module 256 may include the telemetry equipment 252, for example, where the turbine impeller can generate power by flow of the mud; it being understood that other power and/or battery systems may be employed for purposes of powering various components. As an example, the MWD module 256 may include one or more of the following types of measuring devices: a weight-on-bit measuring device, a torque measuring device, a vibration measuring device, a shock measuring device, a stick slip measuring device, a direction measuring device, and an inclination measuring device.

FIG. 2 also shows some examples of types of holes that may be drilled. For example, consider a slant hole 272, an S-shaped hole 274, a deep inclined hole 276 and a horizontal hole 278.

As an example, a drilling operation can include directional drilling where, for example, at least a portion of a well includes a curved axis. For example, consider a radius that defines curvature where an inclination with regard to the vertical may vary until reaching an angle between about 30 degrees and about 60 degrees or, for example, an angle to about 90 degrees or possibly greater than about 90 degrees.

As an example, a directional well can include several shapes where each of the shapes may aim to meet particular operational demands. As an example, a drilling process may be performed on the basis of information as and when it is relayed to a drilling engineer. As an example, inclination and/or direction may be modified based on information received during a drilling process.

As an example, deviation of a bore may be accomplished in part by use of a downhole motor and/or a turbine. As to a motor, for example, a drillstring can include a positive displacement motor (PDM).

As an example, a system may be a steerable system and include equipment to perform method such as geosteering. As mentioned, a steerable system can be or include an RSS. As an example, a steerable system can include a PDM or of a turbine on a lower part of a drillstring which, just above a drill bit, a bent sub can be mounted. As an example, above a PDM, MWD equipment that provides real time or near real time data of interest (e.g., inclination, direction, pressure, temperature, real weight on the drill bit, torque stress, etc.) and/or LWD equipment may be installed. As to the latter, LWD equipment can make it possible to send to the surface various types of data of interest, including for example, geological data (e.g., gamma ray log, resistivity, density and sonic logs, etc.).

The coupling of sensors providing information on the course of a well trajectory, in real time or near real time, with, for example, one or more logs characterizing the formations from a geological viewpoint, can allow for implementing a geosteering method. Such a method can include navigating a subsurface environment, for example, to follow a desired route to reach a desired target or targets.

As an example, a drillstring can include an azimuthal density neutron (ADN) tool for measuring density and porosity; a MWD tool for measuring inclination, azimuth and shocks; a compensated dual resistivity (CDR) tool for measuring resistivity and gamma ray related phenomena; one or more variable gauge stabilizers; one or more bend joints; and a geosteering tool, which may include a motor and optionally equipment for measuring and/or responding to one or more of inclination, resistivity and gamma ray related phenomena.

As an example, geosteering can include intentional directional control of a wellbore based on results of downhole geological logging measurements in a manner that aims to keep a directional wellbore within a desired region, zone (e.g., a pay zone), etc. As an example, geosteering may include directing a wellbore to keep the wellbore in a particular section of a reservoir, for example, to minimize gas and/or water breakthrough and, for example, to maximize economic production from a well that includes the wellbore.

Referring again to FIG. 2, the wellsite system 200 may include one or more sensors 264 that are operatively coupled to the control and/or data acquisition system 262. As an example, a sensor or sensors may be at surface locations. As an example, a sensor or sensors may be at downhole locations. As an example, a sensor or sensors may be at one or more remote locations that are not within a distance of the order of about one hundred meters from the wellsite system 200. As an example, a sensor or sensor may be at an offset wellsite where the wellsite system 200 and the offset wellsite are in a common field (e.g., oil and/or gas field).

As an example, one or more of the sensors 264 can be provided for tracking pipe, tracking movement of at least a portion of a drillstring, etc.

As an example, the system 200 can include one or more sensors 266 that can sense and/or transmit signals to a fluid conduit such as a drilling fluid conduit (e.g., a drilling mud conduit). For example, in the system 200, the one or more sensors 266 can be operatively coupled to portions of the standpipe 208 through which mud flows. As an example, a downhole tool can generate pulses that can travel through the mud and be sensed by one or more of the one or more sensors 266. In such an example, the downhole tool can include associated circuitry such as, for example, encoding circuitry that can encode signals, for example, to reduce demands as to transmission. As an example, circuitry at the surface may include decoding circuitry to decode encoded information transmitted at least in part via mud-pulse telemetry. As an example, circuitry at the surface may include encoder circuitry and/or decoder circuitry and circuitry downhole may include encoder circuitry and/or decoder circuitry. As an example, the system 200 can include a transmitter that can generate signals that can be transmitted downhole via mud (e.g., drilling fluid) as a transmission medium.

As an example, one or more portions of a drillstring may become stuck. The term stuck can refer to one or more of varying degrees of inability to move or remove a drillstring from a bore. As an example, in a stuck condition, it might be possible to rotate pipe or lower it back into a bore or, for example, in a stuck condition, there may be an inability to move the drillstring axially in the bore, though some amount of rotation may be possible. As an example, in a stuck condition, there may be an inability to move at least a portion of the drillstring axially and rotationally.

As to the term “stuck pipe”, this can refer to a portion of a drillstring that cannot be rotated or moved axially. As an example, a condition referred to as “differential sticking” can be a condition whereby the drillstring cannot be moved (e.g., rotated or reciprocated) along the axis of the bore. Differential sticking may occur when high-contact forces caused by low reservoir pressures, high wellbore pressures, or both, are exerted over a sufficiently large area of the drillstring. Differential sticking can have time and financial cost.

As an example, a sticking force can be a product of the differential pressure between the wellbore and the reservoir and the area that the differential pressure is acting upon. This means that a relatively low differential pressure (delta p) applied over a large working area can be just as effective in sticking pipe as can a high differential pressure applied over a small area.

As an example, a condition referred to as “mechanical sticking” can be a condition where limiting or prevention of motion of the drillstring by a mechanism other than differential pressure sticking occurs. Mechanical sticking can be caused, for example, by one or more of junk in the hole, wellbore geometry anomalies, cement, keyseats, or a buildup of cuttings in the annulus.

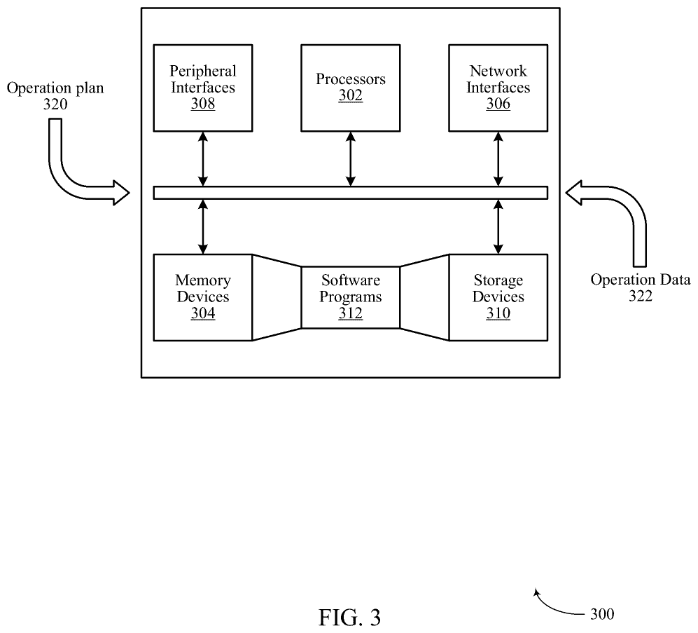

FIG. 3 illustrates a schematic view of a computing or processor system 300 that may be implemented in a system for detecting anomalies and predicting failures in petroleum-industry operations, according to an embodiment. According to various examples, the processor system may identify anomalies in petroleum-industry systems, operations, and equipment, forecast the likelihood of a failure, and estimate a time to failure, as discussed herein. The processor system may automatically assess the condition of equipment, identify potential contributing factors, predict potential trips/failures, and optimize maintenance strategies to minimize downtime can help maximize operational efficiencies.

The processor system 300 may include one or more processors 302 of varying core configurations (including multiple cores) and clock frequencies. The one or more processors 302 may be operable to execute instructions, apply logic, etc. It will be appreciated that these functions may be provided by multiple processors or multiple cores on a single chip operating in parallel and/or communicably linked together. In at least one embodiment, the one or more processors 302 may be or include one or more GPUs.

The processor system 300 may also include a memory system, which may be or include one or more memory devices and/or computer-readable media 304 of varying physical dimensions, accessibility, storage capacities, etc. such as flash drives, hard drives, disks, random access memory, etc., for storing data, such as images, files, and program instructions for execution by the processor 302. In at least one embodiment, the computer-readable media 304 may store instructions that, when executed by the processor 302, are configured to cause the processor system 300 to perform operations. For example, execution of such instructions may cause the processor system 300 to implement one or more portions and/or embodiments of the method(s) described above.

The processor system 300 may also include one or more network interfaces 306. The network interfaces 306 may include any hardware, applications, and/or other software. Accordingly, the network interfaces 306 may include Ethernet adapters, wireless transceivers, PCI interfaces, and/or serial network components, for communicating over wired or wireless media using protocols, such as Ethernet, wireless Ethernet, etc.

As an example, the processor system 300 may be a mobile device that includes one or more network interfaces for communication of information. For example, a mobile device may include a wireless network interface (e.g., operable via one or more IEEE 802.11 protocols, ETSI GSM, BLUETOOTH®, satellite, etc.). As an example, a mobile device may include components such as a main processor, memory, a display, display graphics circuitry (e.g., optionally including touch and gesture circuitry), a SIM slot, audio/video circuitry, motion processing circuitry (e.g., accelerometer, gyroscope), wireless LAN circuitry, smart card circuitry, transmitter circuitry, GPS circuitry, and a battery. As an example, a mobile device may be configured as a cell phone, a tablet, etc. As an example, a method may be implemented (e.g., wholly or in part) using a mobile device. As an example, a system may include one or more mobile devices.

The processor system 300 may further include one or more peripheral interfaces 308, for communication with a display, projector, keyboards, mice, touchpads, sensors, other types of input and/or output peripherals, and/or the like. In some implementations, the components of processor system 300 need not be enclosed within a single enclosure or even located in close proximity to one another, but in other implementations, the components and/or others may be provided in a single enclosure. As an example, a system may be a distributed environment, for example, a so-called “cloud” environment where various devices, components, etc. interact for purposes of data storage, communications, computing, etc. As an example, a method may be implemented in a distributed environment (e.g., wholly or in part as a cloud-based service).

As an example, information may be input from a display (e.g., a touchscreen), output to a display or both. As an example, information may be output to a projector, a laser device, a printer, etc. such that the information may be viewed. As an example, information may be output stereographically or holographically. As to a printer, consider a 2D or a 3D printer. As an example, a 3D printer may include one or more substances that can be output to construct a 3D object. For example, data may be provided to a 3D printer to construct a 3D representation of a subterranean formation. As an example, layers may be constructed in 3D (e.g., horizons, etc.), geobodies constructed in 3D, etc. As an example, holes, fractures, etc., may be constructed in 3D (e.g., as positive structures, as negative structures, etc.).

The memory device 304 may be physically or logically arranged or configured to store data on one or more storage devices 310. The storage device 310 may include one or more file systems or databases in any suitable format. The storage device 310 may also include one or more software programs 312, which may contain interpretable or executable instructions for performing one or more of the disclosed processes. When requested by the processor 302, one or more of the software programs 312, or a portion thereof, may be loaded from the storage devices 310 to the memory devices 304 for execution by the processor 302.

Those skilled in the art will appreciate that the above-described componentry is merely one example of a hardware configuration, as the processor system 300 may include any type of hardware components, including any accompanying firmware or software, for performing the disclosed implementations. The processor system 300 may also be implemented in part or in whole by electronic circuit components or processors, such as application-specific integrated circuits (ASICs) or field-programmable gate arrays (FPGAs).

The processor system 300 may be configured to receive an operational plan 320 (e.g., a drilling well plan). The operational plan may include information associated with the operation, (e.g., drilling of the well), including a description of the operation (e.g., proposed wellbore to be used by the drilling team in drilling the well; the shape, orientation, depth, completion, and evaluation of the borehole), equipment to be used (e.g., a drilling rig), and the length of time scheduled for the operation. The operational plan may also include other information the team planning the operation believes will be relevant/helpful to the team. For example, a directional drilling well plan may include information about how to steer and manage the direction of the well. In some examples, the operational plan may include a length of time estimated to perform the operation or an estimated completion time of the operation. In some examples, the plan may alternatively or additionally include an estimated length of time remaining to finish the operation.

The processor system 300 may be configured to receive data 322 associated with the operation (e.g., drilling data for a drilling operation). The operation data 322 may include data collected by one or more sensors associated with the resources (e.g., equipment) associated with the operation (e.g., surface equipment or downhole equipment for a drilling operation). For example, for a drilling operation, the operation data 322 may include information such as data relating to the position of the BHA (such as survey data or continuous position data), drilling parameters (such as weight on bit (WOB), rate of penetration (ROP), torque, or others), text information entered by individuals working at the wellsite, or other data collected during the construction of the well.

In one embodiment associated with a drilling operation, the processor system 300 may be part of the rig control system (RCS) for a rig. In another embodiment, the processor system 300 may be a separately installed computing unit including a display that may be installed at the operation site and receives data from the operation (e.g., RCS). In such an embodiment, the software on the processor system 300 may be installed on the computing unit, brought to the operation site, and installed and communicatively connected to the operation (e.g., to a rig control system) in preparation for performing the operation (e.g., constructing a well or a portion thereof).

In another embodiment, the processor system 300 may be at a location remote from the operation and receives the operation data 322 over a communications medium using a protocol such as, e.g., well-site information transfer specification or standard (WITS) and markup language (WITSML). In such an embodiment, the software on the processor system 300 may be a web-native application that may be accessed by users using a web browser. In such an embodiment, the processor system 300 may be remote from the operation where the operation is being performed (e.g., the well is being constructed), and the user may be at the operation site (e.g., wellsite) or at a location remote from the operation site.

Although much of the discussion herein focuses on drilling operations, embodiments of the invention may be used on other types of petroleum-industry operations. Some examples may include operations associated with exploration, extraction, processing, refining, and transportation of petroleum products. By way of example and not limitation, embodiments of the invention may be used to detect anomalies and forecast failures in equipment in oil refinery operations, such as pumps, compressors, heat exchangers, gas sweetening units, reboilers, turbines, dehydrators, and the like.

To perform the acts disclosed herein, the processor system 300 may employ a trained model, as discussed herein. In some examples, the processor system 300 may identify anomalies in petroleum-industry systems and equipment, forecast the likelihood of a failure, and/or estimate a time to failure by training a model and then using the trained model. In some examples, machine learning may be employed to train and use the model. For example, the processor system 300 may employ unsupervised clustering and/or deep learning with the data.

In some examples, a machine learning pipeline may be used by the processor system 300 where ML models may be configured and updated for their tasks when there are changes/additions to the input datasets. In this way, the model may be automatically retrained and upgraded when retraining conditions are met. In some examples, the processor system 300 may provide automated model building with feature engineering. The pipeline may be configured to automate the model building process where the most suitable model may be tuned and deployed within the pipeline.

The model builder may include feature engineering steps where algorithms compute features over time and frequency domains for the model development. Subject matter experts may provide additional input features to incorporate into the models to improve performance. These optional input features may be provided when, for example, customization for specific equipment may be beneficial and/or when data availability may be limited.

In some examples, the processor system 300 may implement various algorithms for modeling the equipment on the platform. For example, for anomaly detection and failure forecasting, the system may leverage tree-based algorithms for smaller datasets and deep learning algorithms for larger datasets. In one embodiment, this switch/transition may occur automatically. In one embodiment, contributing factors may be computed based on selected algorithms and the forecasting techniques may be used to determine times to failure for features identified by the algorithms.

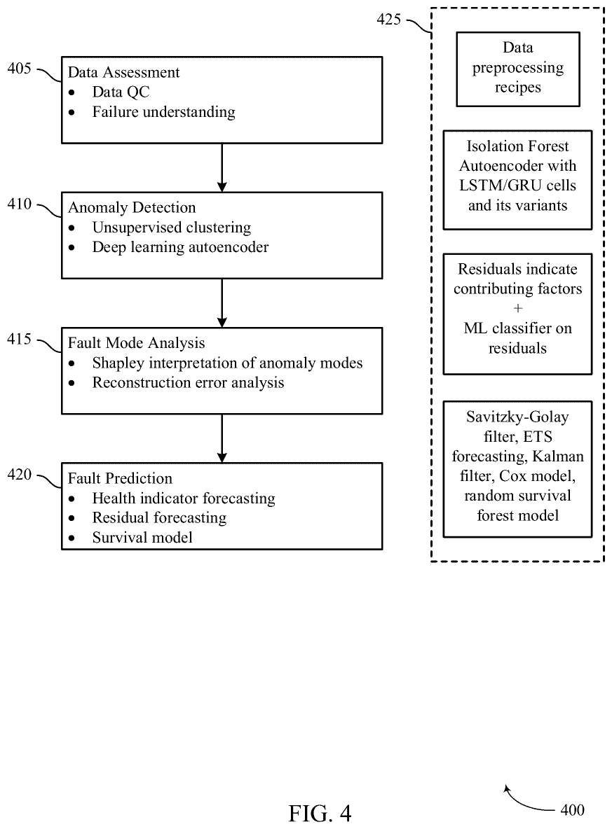

FIG. 4 shows one example of a method 400 that supports detecting anomalies and predicting failures in petroleum-industry operations according to some implementations. In at least one embodiment, prognostics, and health monitoring (PHM) may be used to assess the condition of equipment, predict potential failures, and optimize maintenance strategies to minimize downtime and maximize operational efficiencies. The PHM solution may use data science modeling technologies and platforms, such as: data assessment or pre-processing 405, anomaly detection 410, failure mode analysis 415, and fault prediction 420.

In at least one embodiment, an initial solution evaluation stage 425 may be implemented. During this stage, known statuses of resources (e.g., equipment) may be used to train a model to learn normal behavior and detect anomalies (e.g., abnormalities) when real-time measurements deviate from a normal baseline. In one example, reconstruction errors may be used to determine features contributing to the anomalies. In one example, the prediction of a time to failure may be performed on residuals of features and the prediction may be made upon the aggregation of multi-channel predictions.

In at least one embodiment, training algorithms may be optimized to work with small unlabeled data sets. This may be useful for demonstrating and/or testing a solution for offline test datasets. For example, when offline test datasets are too small for a data-driven approach to work in a fully automated fashion, this approach may be useful. In some examples, for anomaly detection, temporal and spatial engineering steps may be used to create model inputs and then use unsupervised isolation forests to detect anomalies. In some examples, for failure mode analysis, a model-agnostic variable importance method may be implemented to identify top features contributing to the anomalies. In some examples, for fault prediction, noise filtering techniques may be applied, and the filtered data may be used to perform forecasting on selected top critical features rather than, for example, residual forecasting.

Training the model as discussed above may provide many benefits, including:

Problem detection—Problems in the equipment may be timely and proactively identified. This may reduce the possibility of equipment shutdown, production deferment, and expensive repair.

Root cause analysis—Factors contributing to the anomalies may be identified. This may help operators pinpoint the source of the problems.

Predictive maintenance—Forecasting may be performed by determining when features identified from the root cause analysis may likely cross predetermined thresholds. This may provide predictive capability beyond problem detection. The forecasting horizon may use failure records and data availability and may be improved over time.

Scalability—The system may be fully automated, data-driven, and equipment agnostic. It may be scalable as more equipment come online and require little manual configuration. The compute infrastructure may scale up and down automatically with the computing demand. This may make it cost effective for the operator.

Data volume, integration, and compatibility—petroleum-industry equipment may generate a vast amount of data, including sensor readings, operational parameters, and maintenance records. Managing, storing, and analyzing such large volumes of complex data may require advanced data management and analytics capabilities. The system may standardize the data ingestion, integration, model deployment, and orchestration process. This may enable a seamless combination of technological advancements, data management strategies, and model sustenance within the same platform.

In some examples, the PHM framework may include one or more of the following components:

Flexible and retrainable model pipeline—an ML pipeline may be employed, where ML models may be configured and updated for tasks when there are changes and/or additions to the input datasets. In this way, the model may be automatically retrained and upgraded when retraining conditions are met.

Automated model builder with optional feature engineering—The ML pipeline may fully automate the model building process where the selected model is tuned and deployed within the pipeline. The model builder may include feature engineering steps to compute features over time and frequency domains for the model development. In some examples, SMEs may provide additional input features to incorporate into the models to improve its performance.

Scalable platform—the platform may be equipment agnostic and scalable to handle the monitoring of many pieces of equipment and a large number of tags. In one example, each piece of equipment may be monitored as a system where the model is individually customized and maintained using MLOps architecture. As the number of devices/tags increases, the system may automatically provision additional compute clusters and may parallelize the model training, deployment, and equipment monitoring processes.

ML algorithms—algorithms may be implemented for modeling the equipment on the platform. For example, for anomaly detection and failure forecasting, the platform may leverage tree-based algorithms for smaller datasets and then switch to deep learning algorithms for larger datasets. Contributing factors may be computed based on selected algorithms and the forecasting techniques may be used to determine times to failure for features identified by the algorithms.

In one example, the system may offer graphical plots of alarms over time. For example, the system may do so using timestamped anomaly detection scores and statuses. This may facilitate identification of potential failures and interventions.

In one example, top contributing features of a system anomaly may be aggregated by frequency over time. This may facilitate determination of top features contributing to system anomalies at specific times and may help identify factors that contribute to the anomalies.

In one example, alarm rates may be categorized by dataset classifications (e.g., normal vs. test). Dashboards may be used to show alarm rates for the different data sets and/or data sources. This may aid in minimizing the number of false positives in a normal operation period.

In some embodiments, assumptions may be made. For example, the system may assume that some events for the equipment have been derived using SME domain expertise when no operational logs are available having labeled data. This may not be needed where logs are available.

As another example, the system may assume that events are predictable if they are of types that have observable precursors. Not all event types may have observable precursors that correlate to predictable events. In certain situations, without actual event logs, it may not be possible to examine if the events are detectable. Examples of unpredictable events may include, for example, maintenance shutdowns, power surges, and electrical supply failure. Events may be tagged in offline evaluation data sets to provide a reference for computing relevant model performance metrics.

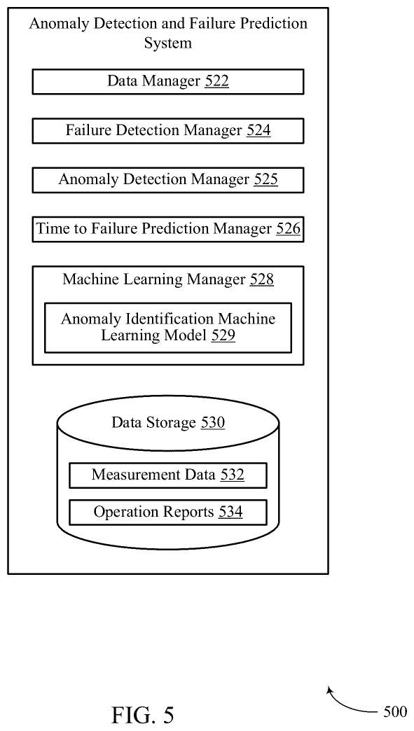

FIG. 5 illustrates an example implementation of an anomaly detection and failure prediction system 500 according to at least one embodiment of the present disclosure. As illustrated, the anomaly detection and failure prediction system 500 may include various components and elements that may be implemented in hardware and/or software. For example, the anomaly detection and failure prediction system 500 may include a data manager 522, a failure detection manager 524, an anomaly detection manager 525, a time to failure prediction manager 526 and a machine learning manager 528, which may implement an anomaly identification machine learning model 529. The anomaly detection and failure prediction system 500 may also include a data storage 530 having measurement data 532 (e.g., wellbore measurement data) and operation reports 534 (e.g., downhole operation reports).

The data manager 522 of the anomaly detection and failure prediction system 500 may receive, collect, or otherwise access a variety of types of data. For example, the data manager 522 may collect, compile, store, and/or manage the various data of the data storage 530. In some embodiments, the data manager 522 may receive and/or initiate requests of the anomaly detection and failure prediction system 500 to identify anomalies within a set of measurement data that may correlate to failures as described herein. In some embodiments, an anomaly that correlates to failure is an anomaly that likely leads to a system failure. In some embodiments, an anomaly that correlates to failure implies causation between the anomaly and the system failures. In some embodiments, an anomaly that correlates to failure is a correlation greater than a pre-determined baseline. In some examples, the pre-determined baseline is a random relationship. In some examples, the pre-determined baseline is determined by a machine learning model. In some examples, the pre-determined baseline is received from or as a user input.

In various embodiments, the failure detection manager 524 may determine failures that have occurred based on the measurement data 532 and, in some cases, operation reports 234. The failure detection manager 524 may also determine time signatures corresponding to the failures.

In various embodiments, the anomaly detection manager 525 may determine system anomalies that occurred that correlated to the failures. The anomaly detection manager 525 may also determine individual anomalies of resources. The anomaly detection manager 525 may also determine time signatures corresponding to the system and/or individual anomalies.

In various embodiments, the time to failure prediction manager 526 may determine an estimated length of time for the system to fail (system time to failure). The time to failure prediction manager 526 may also determine estimated lengths of time for resources to fail (individual times to failure). In some examples, the estimated lengths of time may be based on when the system anomaly has been detected. That is, in some examples, the estimated lengths of time may be measured from when the system anomaly was detected. In some examples, the estimated lengths of time may be determined based on the time signatures corresponding to the system and/or individual anomalies.

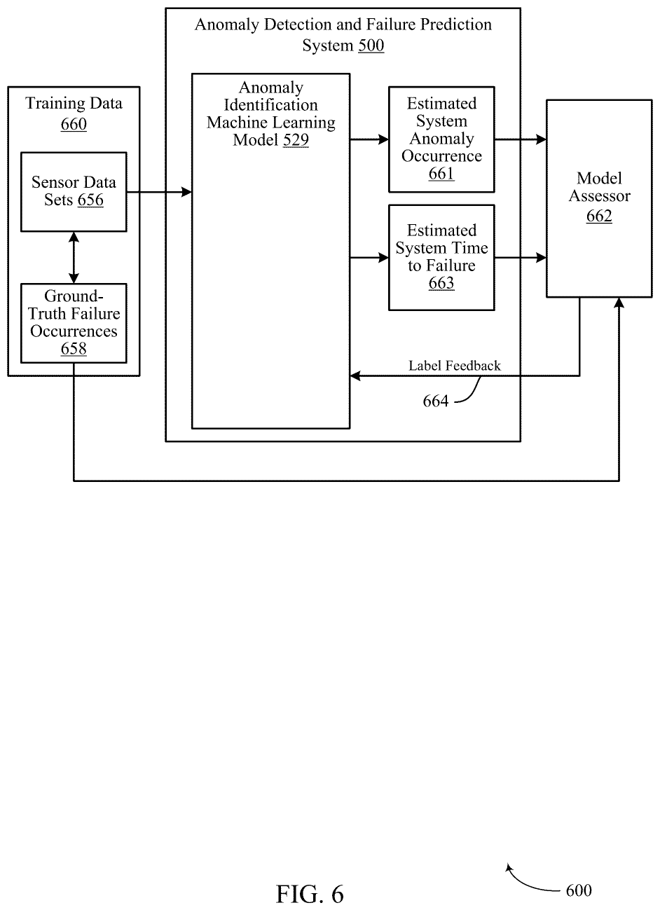

The machine learning manager 528 may facilitate training the anomaly identification machine learning model 529 based on sensor data feature sets generated from the measurement data 532 along with associated failure times determined by the failure detection manager 524. FIG. 6 illustrates the training of the anomaly identification machine learning model 529, including the generation of training data.

The machine learning manager 528 may execute the trained version of the anomaly identification machine learning model 529 based on measurement data 532 for an operation of interest (e.g., a wellbore) to identify system anomalies (and associated times) and individual resource anomalies (and associated times) in the measurement data 532 that may correlate to failures, and estimated lengths of times until the failures may occur (times to failure). In this way, the anomaly detection and failure prediction system 500 may facilitate allowing a time for protective action to be performed before a petroleum-industry operation may fail.

While one or more embodiments described herein describe features and functionalities performed by specific components 522-528 of the anomaly detection and failure prediction system 500, specific features described in connection with any component of the anomaly detection and failure prediction system 500 may be performed by one or more of the other components of the anomaly detection and failure prediction system 500.

By way of example, one or more of the data receiving, gathering, or storing features of the data manager 522 may be delegated to other components of the anomaly detection and failure prediction system 500. Indeed, it will be appreciated that some or all of the specific components may be combined into other components and specific functions may be performed by one or across multiple components 522-528 of the anomaly detection and failure prediction system 500.

Each of the components of the anomaly detection and failure prediction system 500 may be implemented in software, hardware, or both. For example, the components of the anomaly detection and failure prediction system 500 may include instructions stored on a computer-readable storage medium and executable by at least one processor of one or more computing devices. When executed by the processor, the computer-executable instructions of the anomaly detection and failure prediction system 500 may cause a computing device to perform the methods (e.g., computer-implemented methods) described herein. As another example, the components of the anomaly detection system may include hardware, such as a special-purpose processing device, to perform a certain function or group of functions. In some instances, the components of the anomaly detection system may include a combination of computer-executable instructions and hardware.

Furthermore, the components of the anomaly detection system may be implemented as one or more operating systems, stand-alone applications, modules of an application, plug-ins, library functions, functions called by other applications, and/or cloud-computing models. Additionally, the components of the anomaly detection system may be implemented as one or more web-based applications hosted on a remote server and/or implemented within a suite of mobile device applications or “apps.”

As mentioned above, the anomaly detection and failure prediction system 500 may use an anomaly identification machine learning model 529 to determine system anomalies that may correlate to failures and estimated times until the failures may occur. Accordingly, FIG. 6 illustrates an example block diagram 600 of training an anomaly identification machine learning model to detect anomalies and predict failures in petroleum-industry operations.

As shown, FIG. 6 includes training data 660, the anomaly detection and failure prediction system 500 with an anomaly identification machine learning model 529, and a model evaluator 662 (e.g., a loss model or an evaluation model). The training data 660 may include sensor data sets 656 and ground-truth failure occurrences 658. In one or more implementations, the sensor data sets 656 are generated from measurement data (e.g., wellbore measurement data).

Training data may be generated from reference data, according to some implementations. The reference data may include measurement data. In some implementations, the reference data may be associated or correlated with one or more reference operations for which the measurement data have already been collected. For example, the reference data may be accessible through a database or library including information for many petroleum-industry operations, such as wellbores.

The anomaly detection and failure prediction system 500 may receive the reference data and may identify system failures along with time signatures corresponding to the failures based on the reference data. The anomaly detection and failure prediction system 500 may further identify system anomalies that may have led to the system failures along with time signatures corresponding to the system anomalies. In some examples, for each of the system anomalies, a corresponding time signature that establishes a time point associated with the system anomaly and a time point associated with a system failure that may have occurred as a result of the anomaly may be determined. In some examples, an estimated system time to failure may be determined based on the time points.

The anomaly detection and failure prediction system 500 may train the anomaly identification machine learning model 529 using the training data 660. The anomaly identification machine learning model 529 may be trained to determine when a system anomaly 661 has occurred that led to a system failure and an estimated amount of time until the system is likely to fail 663 based on the statistical characterizations included in the training data 660. The anomaly identification machine learning model 529 is often trained offline but may be trained on the fly.

In various implementations the anomaly identification machine learning model 529 may include a tree-based architecture having one or more hierarchical, tree-like structures. In various instances, the anomaly identification machine learning model 529 may be a decision tree model, a random forest or ensemble of decision trees, or a gradient boosting model.

To elaborate, in some instances, the anomaly identification machine learning model 529 may be a tree-based model that includes a hierarchical structure of decision nodes, branches, and leaf nodes. Each node may represent a decision based on a specific feature and each leaf may represent a candidate system anomaly for which the anomaly identification machine learning model 529 may classify the statistical sensor data sets 656. The tree-based structure may be built through the recursive splitting of the decision nodes into further decision nodes through training of the anomaly identification machine learning model 529, as described below.

In some instances, the anomaly detection and failure prediction system 500 may utilize a leaf-based model for the anomaly identification machine learning model 529. A leaf-based model may allow the anomaly detection and failure prediction system 500 to use unbalanced growth and/or splitting among nodes to minimize losses of nodes. In various implementations, the anomaly detection and failure prediction system 500 may implement a light gradient boosting machine architecture (LGBM or Light GBM) along with the leaf-based model. For example, the anomaly detection and failure prediction system 500 may use an LGBM classifier to identify anomalies that correlate to failures in petroleum industry operations.

In various implementations, the anomaly detection and failure prediction system 500 may process each input sensor data set and generate an input feature vector or a dimensional array containing numerical values each representing one of the various attributes of a statistical data set. The anomaly identification machine learning model 529 may then process the feature vector through a sequence of decision nodes, where the anomaly identification machine learning model 529 may evaluate a specific feature of the input vector and make a decision based on the feature's value. In this way, the anomaly identification machine learning model 529 may recursively navigate through the tree structure, making decisions at each node based on different features until a leaf node is reached, providing the final output prediction of an occurrence of a system anomaly 661 that may correlate to failure and/or an associated estimated system time to failure 663.

In some embodiments, the anomaly identification machine learning model 529 may include an ensemble architecture that utilizes multiple decision trees. For example, the anomaly identification machine learning model 529 may process the input vector through separate decision trees independently. The outputs may then be combined, such as through voting or averaging, to generate a final ensemble prediction of an occurrence of a system anomaly 661 and/or an associated estimated system time to failure 663.

In some embodiments, the anomaly identification machine learning model 529 may determine a probability or confidence of the occurrence of a system anomaly 661 and/or an estimated system time to failure 663. For example, the probability may be determined based on the voting of the various trees, based on a logistic function such as an LGBM classifier, through calibration techniques such as Platt scaling or isotonic regression, or any other suitable technique for determining multi-classification probabilities.

In implementations where the anomaly identification machine learning model 529 determines several of the candidate anomalies as possible outputs, the anomaly identification machine learning model 529 may determine a confidence or probability of each of these possibilities (or all of the candidate anomalies). The estimated system anomaly 661 and/or associated estimated system time to failure 663 may be determined by the anomaly identification machine learning model 529 based on having a highest probability among the candidate anomalies.

As mentioned, the anomaly identification machine learning model 529 may not converge to a single candidate anomaly but may return several candidate anomalies as possible outputs for a given time point of the training data 660. In some implementations, the anomaly identification machine learning model 529 may combine the several candidate anomaly predictions, such as through voting or averaging, to generate a final ensemble prediction of an estimated system anomaly 661 to determine an estimated system anomaly and/or associated estimated system time to failure.

In some embodiments, the anomaly identification machine learning model 529 may output a null anomaly indicating that no system anomaly took place that led to a system failure at an associated time point of the training data 660. For example, the anomaly identification machine learning model 529 may be trained to output a null anomaly based on each of the candidate system anomalies having a probability below an anomaly threshold value.

In some implementations, the anomaly identification machine learning model 529 may be implemented as another type of machine learning model, such as a neural network architecture. For example, the anomaly identification machine learning model 529 may be a Monte Carlo Dropout prediction model, a U-Net neural network, or a U-Net++ neural network.

As mentioned above, the anomaly detection and failure prediction system 500 may train the anomaly identification machine learning model 529 based on the training data 660. For example, the anomaly detection and failure prediction system 500 may provide the sensor data sets 656 for a given time point to the anomaly identification machine learning model 529, and the anomaly identification machine learning model 529 may predict or determine an occurrence of a system anomaly 661 at the given time point that led to a system failure. Additionally, the anomaly identification machine learning model 529 may forecast an estimated system time to failure 663 based on the occurrence and time point of the system anomaly. The estimated system anomaly 661 and estimated system time to failure 663, along with the ground-truth anomaly failure occurrence for the time point, may be provided to the model evaluator 662 to evaluate the performance of the anomaly identification machine learning model 529 during the training process.

In some examples, the model evaluator 662 may include a loss model that implements one or more loss functions or techniques to determine estimated system anomaly error amounts. In various implementations, the one or more loss functions or techniques may include cross-entropy loss, Gini impurity, deviance, etc. to determine an estimated system anomaly error amount. In other examples, the model evaluator 662 may include an evaluation model that implements performance metrics to assess the overall performance of the model. The evaluation model may provide a high-level summary of how well the model generalizes to new, unseen data. In various implementations, the anomaly detection and failure prediction system 500 may provide feedback (e.g., the error or loss amount) back to the anomaly identification machine learning model 529 as label feedback 664 to train and fine-tune the anomaly identification machine learning model.

Additionally, in one or more implementations, the anomaly detection and failure prediction system 500 may use the label feedback 664 to train, optimize, and/or fine-tune the decision tree(s) of the anomaly identification machine learning model 529 through techniques such as recursive partitioning and/or boosting. For example, the anomaly detection and failure prediction system 500 may use the model evaluator 662 to facilitate selecting a feature and corresponding threshold for generating or splitting corresponding decision nodes to generate one or more decision trees.

As another example, the anomaly detection and failure prediction system 500 may use the model evaluator 662 to facilitate generating trees sequentially, with each tree correcting the errors of the previous tree. The anomaly detection and failure prediction system 500 may iteratively train the anomaly identification machine learning model 529 in this way with respect to many time points of the training data 660 to further fine-tune the anomaly identification machine learning model 529 for a set number of iterations, until it converges, until the training data is exhausted, or until a satisfactory level of accuracy is otherwise achieved.

As described earlier, in some embodiments, the anomaly detection and failure prediction system 500 may generate training data 660 that includes sensor data sets 656 generated by the anomaly detection and failure prediction system 500 in relation to the measurement data. In these implementations, the anomaly detection and failure prediction system 500 may train the anomaly identification machine learning model 529 directly based on the measurement data (e.g., raw or processed data). For example, the anomaly detection and failure prediction system 500 may provide the measurement data from one or more data sources directly to the anomaly identification machine learning model 529 rather than pre-processing the measurement data into a statistical attribute set.

To elaborate, in various implementations, the anomaly identification machine learning model may be trained to determine an occurrence of a system anomaly 661 based on the identifying patterns, relationships, statistical characterizations, and other attributes directly from the measurement data. In some cases, the anomaly detection and failure prediction system 500 may generate an input feature vector representing these various features identified from the measurement data and may process the input feature vector through the series of nodes of the anomaly identification machine learning model to determine system anomalies and/or anomaly times.

In these implementations, the anomaly identification machine learning model 529 may recursively process the measurement data as input through the tree and leaf architecture to provide a final output prediction of an occurrence of a system anomaly 661. Then, the anomaly detection and failure prediction system 500 may use the model evaluator 662 to fine-tune the predictions of the anomaly identification machine learning model 529. In this way, the anomaly identification machine learning model 529 may be trained to predict system anomaly occurrences for an operation based on measurement data from the operation.

Once trained, in various implementations, the anomaly detection and failure prediction system 500 may use the anomaly identification machine learning model 529 to automatically detect system anomalies that may correlate to system failures for an operation of interest.

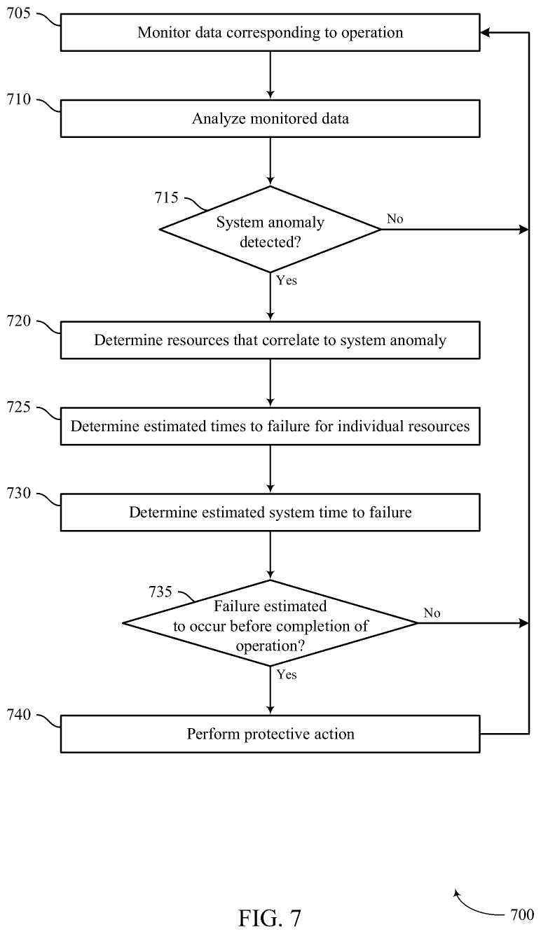

FIG. 7 shows a flowchart illustrating a method 700 that supports detecting anomalies and predicting failures in petroleum-industry operations in accordance with examples as disclosed herein. Alternative implementations may omit, add to, reorder, and/or modify any of the acts shown. The operations of method 700 may be implemented by a processing system or its components as described herein. For example, the operations of method 700 may be performed by a processing system as described with reference to FIGS. 2 through 6. Alternatively, a computer-readable medium may include instructions that, when executed by a processing system with a processor, cause the processing system to perform the acts of FIG. 7.

Data associated with an operation may be monitored until a system anomaly is detected that may correlate to a system failure. After the detection of the system anomaly, an estimated system time to failure may be determined based on estimated individual times to failure associated with resources that correlate with the system anomaly. The system time to failure may be compared with the length of time remaining for the operation to determine if the failure is likely to occur before the operation is complete. If so, a protective action may be performed to protect the resources associated with the operation.

At act 705, data corresponding to resources of a petroleum-industry operation may be monitored. In some examples, the data may be monitored in real-time or near real-time. In some examples, the data may be received from sensors associated with the resources. The data may be obtained periodically or continuously during operations. The petroleum-industry operation may be a drilling operation, a refining operation, or any other type of petroleum-industry operation.

At act 710, the monitored data may be analyzed to determine or detect if a system anomaly associated with the petroleum-industry operation has occurred that correlates to a system failure (e.g., is likely (e.g., estimated) to lead to a system failure). In some examples, the analysis may be performed dynamically on the fly (e.g., in or close to real-time). In some examples, the system anomaly may be detected using a trained model. In some examples, the system anomaly may be detected using unsupervised clustering or deep learning autoencoding applied to the monitored data. In some examples, the system anomaly may be based on individual anomalies associated with resources associated with the petroleum-industry operation. The individual anomalies may be determined based on data received from sensors associated with the resources.

In some examples, a system anomaly score may be determined for a system anomaly. In some examples, the system anomaly score may be based on individual anomaly scores associated with anomalies associated with the resources. In some examples, the system anomaly score may be an aggregate of the individual anomaly scores. In some examples, the system anomaly score may be compared to a threshold to determine if the system anomaly may correlate to a system failure. In some examples, the threshold may be determined using a trained model. For example, the threshold may be determined by training an anomaly detection model to determine a system anomaly score threshold that is estimated to correlate to a system failure.

At act 715, it may be determined whether the monitored data satisfies a condition indicating that a system anomaly has occurred that correlates to a system failure, e.g., is likely (e.g., estimated) to lead to a system failure. In some examples, the condition may be met if a value of a system anomaly score (e.g., determined at act 710) satisfies a system anomaly score threshold.

If a condition is satisfied indicating that a system anomaly has occurred that correlates to a system failure, the method may continue to act 720. Otherwise, if a condition is not satisfied indicating that a system anomaly has occurred that correlates to a system failure, the method may return to act 705 to continue monitoring data corresponding to the operation.

At act 720, the resources that correlate most with the system anomaly may be determined. The resources may be those associated with the monitored data. In some examples, the resources that correlate most with the system anomaly may be based on anomalies associated with the individual resources. In some examples, individual anomaly scores may be determined for the individual anomalies associated with the individual resources and the resources that correlate with the system anomaly may be based on the individual anomaly scores. For example, the correlation of the resources with the system anomaly may be directly proportional to the individual anomaly scores associated with the resources. For example, the resources associated with the highest individual anomaly scores may be determined to be the resources that correlate most with the system anomaly.

In some examples, the number of resources that correlate with the system anomaly may be limited. In some examples, the number of resources may be limited to those associated with individual anomaly scores that meet a threshold value. In other examples, the number of resources may be limited to a certain value. For example, the number of resources may be limited to the top three, or four, or five resources associated with the highest individual anomaly scores. Other number of resources may also be used.

Once the resources that correlate with the system anomaly have been determined, feature forecasting of selected top features may be performed. At act 725, estimated times to failure may be determined for the individual resources. In some examples, the estimated times to failure may be determined for the resources that correlate with the system anomaly, as determined at act 720. In some examples, the estimated individual time to failure of a resource may be based on the individual anomaly score associated with the resource. For example, the estimated individual time to failure of a resource may be based on the associated individual anomaly score having a certain probability of meeting a certain threshold. The forecasting capability may be dynamically adjusted based on the characteristics of individual features and designed to be adaptive to underlying variations of time series trending inherent in the data patterns.

In some examples, the individual anomaly score threshold may be based on industry standards, such as SME standards. In some examples, the estimated times to failure may be detected using a trained model. In some examples, the estimated times to failure may be detected using machine learning. In some examples, an estimated time to failure may not be determinable for one or more of the resources. In those cases, the estimated times to failure may not be determined for those resources.

At act 730, an estimated system time to failure may be determined. In some examples, the system time to failure may be determined using machine learning. In some examples, the system time to failure may be based on the estimated individual times to failure associated with the individual resources. In some examples, the system time to failure may be determined to be the shortest time to failure associated with the individual resources that correlate with the system anomaly.

At act 735, it may be determined whether system failure of the operation is estimated to occur before the scheduled completion of the operation. For example, the condition may be met if the estimated system time to failure is less than the scheduled remaining time for the operation to be performed. Otherwise, the system failure may not likely occur, so it may be disregarded.

If a condition is satisfied indicating system failure is estimated to occur before the scheduled completion of the operation, the method may continue to act 740. Otherwise, if a condition is not satisfied indicating system failure is estimated to occur before the scheduled completion of the operation, the method may return to act 705 to continue monitoring data corresponding to the operation.

At act 740, a protective action may be performed to protect the system and its resources against potential system failure. In some examples, the protective action may include shutting down equipment associated with the petroleum-industry operation. In some examples, the protective action may include providing a warning to an operator. Then, the operator can decide how to mitigate against the potential failure.

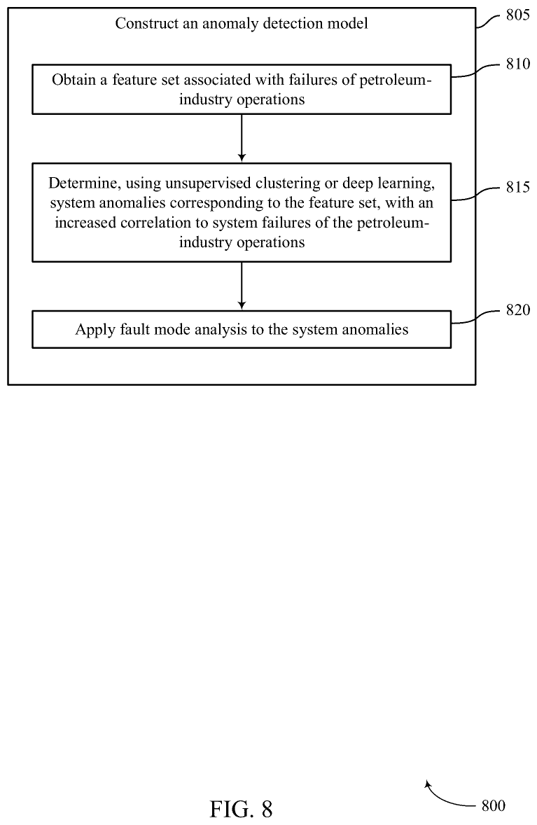

FIG. 8 shows a flowchart illustrating a method 800 that supports detecting anomalies and predicting failures in petroleum-industry operations in accordance with examples as disclosed herein. The method may be for protecting resources associated with petroleum-industry operations. Alternative implementations may omit, add to, reorder, and/or modify any of the acts shown. The operations of method 800 may be implemented by a processing system or its components as described herein. For example, the operations of method 800 may be performed by a processing system as described with reference to FIGS. 2 through 6. Alternatively, a computer-readable medium may include instructions that, when executed by a processing system with a processor, cause the processing system to perform the acts of FIG. 8

At act 805, the method may include constructing an anomaly detection model. The operations of act 805 may be performed in accordance with examples as disclosed herein. Act 805 may include acts 810, 815, and 820.

At act 810, the method may include obtaining a feature set associated with failures of petroleum-industry operations. The operations of act 810 may be performed in accordance with examples as disclosed herein.

At act 815, the method may include determining, using unsupervised clustering or deep learning, system anomalies, corresponding to the feature set, with an increased correlation to system failures of the petroleum-industry operations. In some embodiments, the increased correlation indicates the system anomaly(ies) likely leads to the system failure(s). In some embodiments, the increase correlation implies causation between the system anomaly(ies) and the system failure(s). In some embodiments, an increased correlation is any correlation greater than a pre-determined baseline. In some examples, the pre-determined baseline is a random relationship. In some examples, the pre-determined baseline is determined by a machine learning model. In some examples, the pre-determined baseline is received from or as a user input. The operations of act 815 may be performed in accordance with examples as disclosed herein.

At act 820, the method may include applying fault mode analysis to the system anomalies. The operations of act 820 may be performed in accordance with examples as disclosed herein.

In some examples, an apparatus as described herein may perform a method such as the method 800. The apparatus may include, features, circuitry, logic, means, or instructions (e.g., a non-transitory computer-readable medium storing instructions executable by a processor) for constructing an anomaly detection model that includes obtaining a feature set associated with failures of petroleum-industry operations, determining, using unsupervised clustering or deep learning, system anomalies corresponding to the feature set, with an increased correlation to system failures of the petroleum-industry operations, and applying fault mode analysis to the system anomalies.

Some examples of the method 800 and the apparatus described herein may further include operations, features, circuitry, logic, means, or instructions for performing a protective action to protect resources associated with the petroleum-industry operations based on applying the anomaly detection model analysis.

In some examples of the method 800 and the apparatus described herein, determining the system anomalies with an increased correlation to system failures may include determining a system anomaly score for a system anomaly associated with a petroleum-industry operation and determining that the system anomaly score meets a threshold that when met, has an increased correlation to a system failure of the petroleum-industry operation.

Some examples of the method 800 and the apparatus described herein may further include operations, features, circuitry, logic, means, or instructions for training the anomaly detection model to determine a system anomaly score threshold that when met, has an increased correlation to the system failure.

In some examples of the method 800 and the apparatus described herein, determining the system anomalies with an increased correlation to system failures may include determining individual anomaly scores for individual anomalies associated with the resources associated with the petroleum-industry operations. In some examples, the system anomaly scores may be based on the individual anomaly scores.

In some examples of the method 800 and the apparatus described herein, applying the fault mode analysis may include determining which of the individual anomalies associated with the resources correlate to the system anomalies.

Some examples of the method 800 and the apparatus described herein may further include operations, features, circuitry, logic, means, or instructions for determining estimated times to failure associated with the system anomalies based on the fault mode analysis.

In some examples of the method 800 and the apparatus described herein, performing the protective action may include shutting down equipment associated with the petroleum-industry operation based on the fault mode analysis.

In some examples of the method 800 and the apparatus described herein, performing the protective action may include providing a warning to an operator.

Some examples of the method 800 and the apparatus described herein may further include operations, features, circuitry, logic, means, or instructions for training the anomaly detection model to determine individual anomalies that correlate to system anomalies.

Some examples of the method 800 and the apparatus described herein may further include operations, features, circuitry, logic, means, or instructions for training the anomaly detection model to determine individual anomaly score thresholds that when met, have an increased correlation to failure of the resource.

Some examples of the method 800 and the apparatus described herein may further include operations, features, circuitry, logic, means, or instructions for determining estimated individual times to failure for the individual anomalies that correlate to the system anomaly.

Some examples of the method 800 and the apparatus described herein may further include operations, features, circuitry, logic, means, or instructions for determining estimated times to failure for the petroleum-industry operations based on the fault mode analysis.

In some examples of the method 800 and the apparatus described herein, determining an estimated system time to failure may include determining estimated individual times to failure for the individual anomalies that correlate to the system anomaly.

In some examples of the method 800 and the apparatus described herein, determining an estimated system time to failure may include determining that the estimated system time to failure is the shortest of the estimated individual times to failure.

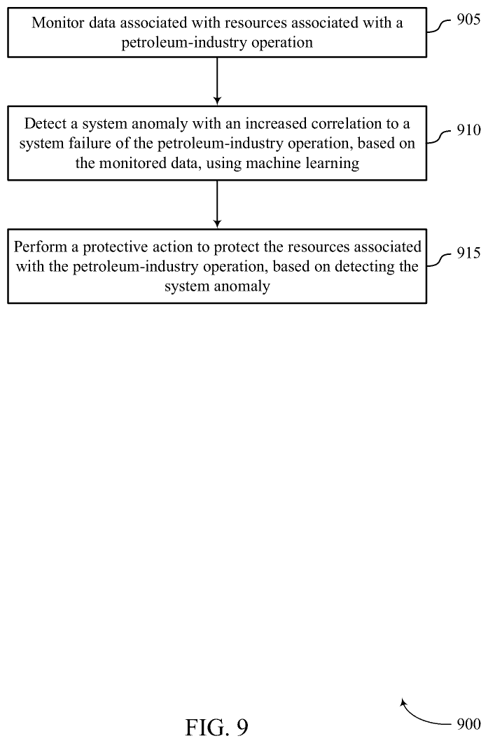

FIG. 9 shows a flowchart illustrating a method 900 that supports detecting anomalies and predicting failures in petroleum-industry operations in accordance with examples as disclosed herein. The method may be for protecting resources associated with petroleum-industry operations. Alternative implementations may omit, add to, reorder, and/or modify any of the acts shown. The operations of method 900 may be implemented by a processing system or its components as described herein. For example, the operations of method 900 may be performed by a processing system as described with reference to FIGS. 2 through 6. Alternatively, a computer-readable medium may include instructions that, when executed by a processing system with a processor, cause the processing system to perform the acts of FIG. 9

At act 905, the method may include monitoring data associated with resources associated with a petroleum-industry operation. The operations of act 905 may be performed in accordance with examples as disclosed herein.

At act 910, the method may include detecting a system anomaly with an increased correlation to a system failure of the petroleum-industry operation, based on the monitored data, using machine learning. The operations of act 910 may be performed in accordance with examples as disclosed herein.

At act 915, the method may include performing a protective action to protect the resources associated with the petroleum-industry operation, based on detecting the system anomaly. The operations of act 915 may be performed in accordance with examples as disclosed herein.

In some examples, an apparatus as described herein may perform a method such as the method 900. The apparatus may include, features, circuitry, logic, means, or instructions (e.g., a non-transitory computer-readable medium storing instructions executable by a processor) for monitoring data received from resources associated with a petroleum-industry operation, detecting a system anomaly with an increased correlation to a system failure of the petroleum-industry operation, based on the monitored data, using machine learning, and performing a protective action to protect the resources associated with the petroleum-industry operation, based on detecting the system anomaly.

In some examples of the method 900 and the apparatus described herein, the system anomaly may be detected using unsupervised clustering or deep learning autoencoding applied to the monitored data.

Some examples of the method 900 and the apparatus described herein may further include operations, features, circuitry, logic, means, or instructions for determining a cause of the system anomaly after detecting the system anomaly. In some examples, performing the protective action may be based on determining the cause of the system anomaly.

Some examples of the method 900 and the apparatus described herein may further include operations, features, circuitry, logic, means, or instructions for determining, after detecting the system anomaly, a length of time until a system failure of the petroleum-industry operation is estimated to occur, using machine learning.

Some examples of the method 900 and the apparatus described herein may further include operations, features, circuitry, logic, means, or instructions for determining, after detecting the system anomaly, which of the resources associated with the petroleum-industry operation correlate to the system anomaly. Some examples of the method 900 and the apparatus described herein may further include operations, features, circuitry, logic, means, or instructions for, determining individual estimated times to failure for the resources that correlate to the system anomaly. In some examples, the length of time until the system failure is estimated to occur may be based on the individual estimated times to failure.

In some examples of the method 900 and the apparatus described herein, performing the protective action may be based on the length of time until a system failure of the petroleum-industry operation is estimated to occur being less than a length of time that the petroleum-industry operation is scheduled to be performed.

Some examples of the method 900 and the apparatus described herein may further include operations, features, circuitry, logic, means, or instructions for determining a system anomaly score for the system anomaly based on the monitored data. In some examples of the method 900 and the apparatus described herein, detecting the system anomaly may include determining that the system anomaly score meets a system anomaly score threshold.

Some examples of the method 900 and the apparatus described herein may further include operations, features, circuitry, logic, means, or instructions for determining the system anomaly score threshold.

Some examples of the method 900 and the apparatus described herein may further include operations, features, circuitry, logic, means, or instructions for determining individual anomaly scores for individual anomalies associated with the resources, based on the monitored data. In some examples, the system anomaly score may be based on the individual anomaly scores.

Some examples of the method 900 and the apparatus described herein may further include operations, features, circuitry, logic, means, or instructions for determining, after detecting the system anomaly, which of the resources correlate to the system anomaly. In some examples, the resources that correlate to the system anomaly are based on the individual anomaly scores.

In some examples of the method 900 and the apparatus described herein, determining which of the resources correlate to the system anomaly may include determining individual anomalies associated with individual resources.

Some examples of the method 900 and the apparatus described herein may further include operations, features, circuitry, logic, means, or instructions for determining estimated individual times to failure for the resources that correlate to the system anomaly.

Some examples of the method 900 and the apparatus described herein may further include operations, features, circuitry, logic, means, or instructions for determining an estimated system time to failure based on the estimated individual times to failure.

Some examples of the method 900 and the apparatus described herein may further include operations, features, circuitry, logic, means, or instructions for determining a length of time until a system failure is likely to occur using machine learning.

In some examples of the method 900 and the apparatus described herein, performing the protective action may be based on the length of time until a system failure is estimated to occur.

In some examples of the method 900 and the apparatus described herein, performing the protective action may be based on the length of time until a system failure is estimated to occur being less than a length of time that the petroleum-industry operation is scheduled to be performed.

In some examples of the method 800 and the apparatus described herein, determining the estimated system time to failure may include determining that the estimated system time to failure is the shortest of the estimated individual times to failure.

In some examples of the method 900 and the apparatus described herein, performing the protective action may include shutting down equipment associated with the petroleum-industry operation.

In some examples of the method 900 and the apparatus described herein, performing the protective action may include providing a warning to an operator.

In some examples of the method 900 and the apparatus described herein, the petroleum-industry operation may include a drilling operation, a refining operation, or other type of operation.

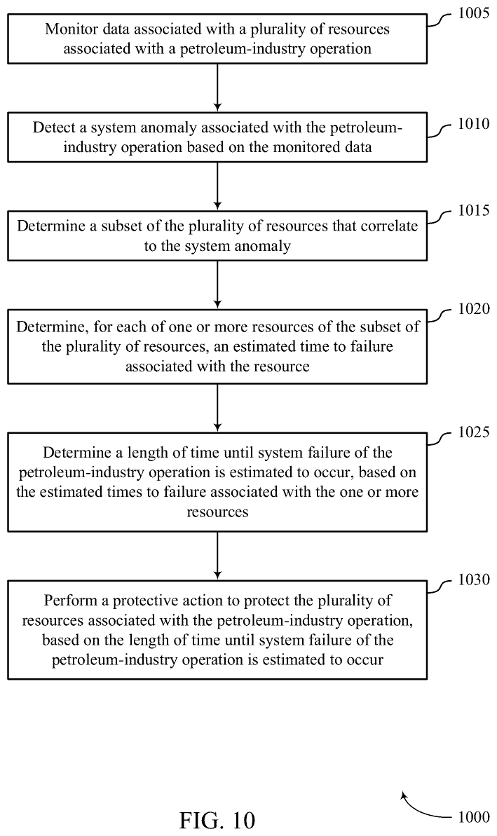

FIG. 10 shows a flowchart illustrating a method 1000 that supports detecting anomalies and predicting failures in petroleum-industry operations in accordance with examples as disclosed herein. The method may be for protecting resources associated with petroleum-industry operations. Alternative implementations may omit, add to, reorder, and/or modify any of the acts shown. The operations of method 1000 may be implemented by a processing system or its components as described herein. For example, the operations of method 1000 may be performed by a processing system as described with reference to FIGS. 2 through 6. Alternatively, a computer-readable medium may include instructions that, when executed by a processing system with a processor, cause the processing system to perform the acts of FIG. 10

At act 1005, the method may include monitoring data associated with a plurality of resources associated with a petroleum-industry operation. The operations of act 1005 may be performed in accordance with examples as disclosed herein.

At act 1010, the method may include detecting a system anomaly associated with the petroleum-industry operation based on the monitored data. The operations of act 1010 may be performed in accordance with examples as disclosed herein.

At act 1015, the method may include determining a subset of the plurality of resources that correlate to the system anomaly. The operations of act 1015 may be performed in accordance with examples as disclosed herein.

At act 1020, the method may include determining, for each of one or more resources of the subset of the plurality of resources, an estimated time to failure associated with the resource. The operations of act 1020 may be performed in accordance with examples as disclosed herein.

At act 1025, the method may include determining a length of time until system failure of the petroleum-industry operation is estimated to occur, based on the estimated times to failure associated with the one or more resources. The operations of act 1025 may be performed in accordance with examples as disclosed herein.

At act 1030, the method may include performing a protective action to protect the plurality of resources associated with the petroleum-industry operation. In some examples, performing the protective action may be based on determining the length of time until system failure of the petroleum-industry operation is estimated to occur. The operations of act 1030 may be performed in accordance with examples as disclosed herein.

In some examples, an apparatus as described herein may perform a method such as the method 1000. The apparatus may include, features, circuitry, logic, means, or instructions (e.g., a non-transitory computer-readable medium storing instructions executable by a processor) for monitoring data received from a plurality of resources associated with a petroleum-industry operation, detecting a system anomaly associated with the petroleum-industry operation based on the monitored data, determining a subset of the plurality of resources that correlate to the system anomaly, determining, for each of one or more resources of the subset of the plurality of resources, an estimated time to failure associated with the resource, determining a length of time until system failure of the petroleum-industry operation is estimated to occur, based on the estimated times to failure associated with the one or more resources, and performing a protective action to protect the plurality of resources associated with the petroleum-industry operation, based on determining the length of time until system failure of the petroleum-industry operation is estimated to occur.

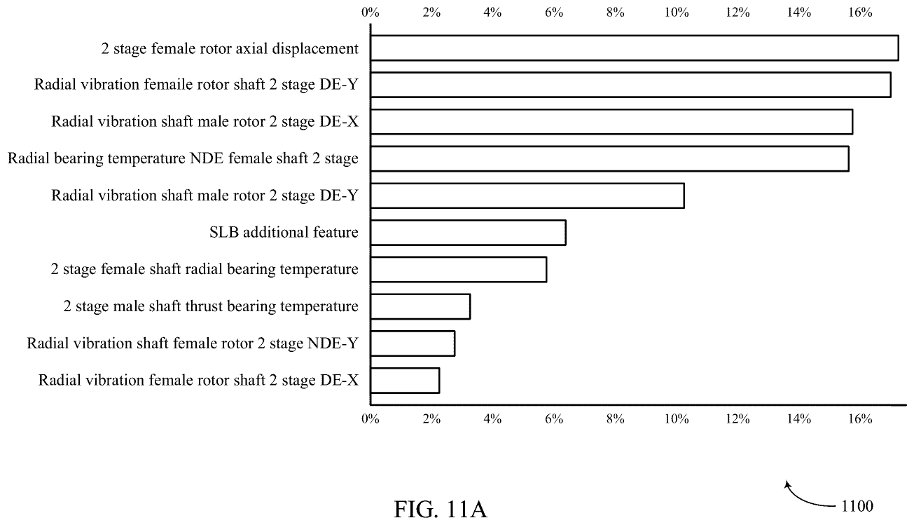

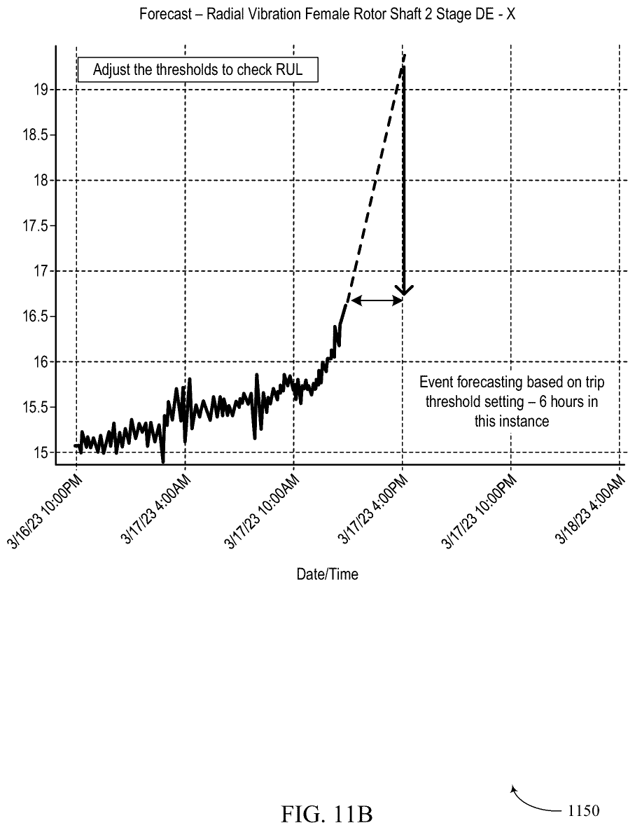

FIGS. 11 through 13 reflect actual results determined by a system for various types of equipment using techniques described herein for three different types of operations. For data preprocessing, additional features were added based on SME knowledge to help improve result accuracy of the model. To evaluate the accuracy of alarms prior to the events (e.g., failures), we evaluated the alarms based on events that are defined by SME in the test dataset and that were detected when: (a) the equipment was left on for at least three days or longer and/or (b) the “on” duration was interrupted by an SME-defined event (which may be the benchmark for the accuracy of the alarms). We computed the rate at which alarms were detected within pre-event periods of 3 days and 7 days. That is, we computed the percentage of the alarms that the anomaly detection system detected within 3 days and 7 days prior to the event. To simplify things, we assumed that alarms detected more than 7 days prior to an event may not be relevant to the event per se.

FIGS. 11A and 11B correspond to results obtained for a compressor used in a gas compressor of an oil refinery operation. The following criteria were used to define the status of the A2 compressor dataset: the status was based on the rotation of the 2nd stage (Keyphasor) (XT_829) and was considered “off” if the rotation was between the 5th and 95th percentile values.

When the compressor was on, the model detected anomalies at a rate of 2.6% in a normal dataset and 7.3% in a test dataset. Using the anomaly detection model on a system with four “on” periods of three days or longer, 81.4% of anomalies that would lead to failure were detected within three days prior to the events and 93.0% within seven days prior to the events.

FIG. 11A shows the top features 1100 aggregating from the anomalies we detected in the compressor. Note that the top features contributing to anomalies may vary with time. FIG. 11B shows a graph 1150 illustrating the estimated time of failure for the radial vibration female rotor shaft 2 stage DE-X, using feature forecasting as explained above. This was one of the top features that correlated to the system anomaly, as identified by the anomaly analysis model. As shown by the forecasting of this feature, the value is expected to reach a potential emergency shutdown threshold within 6 hours.

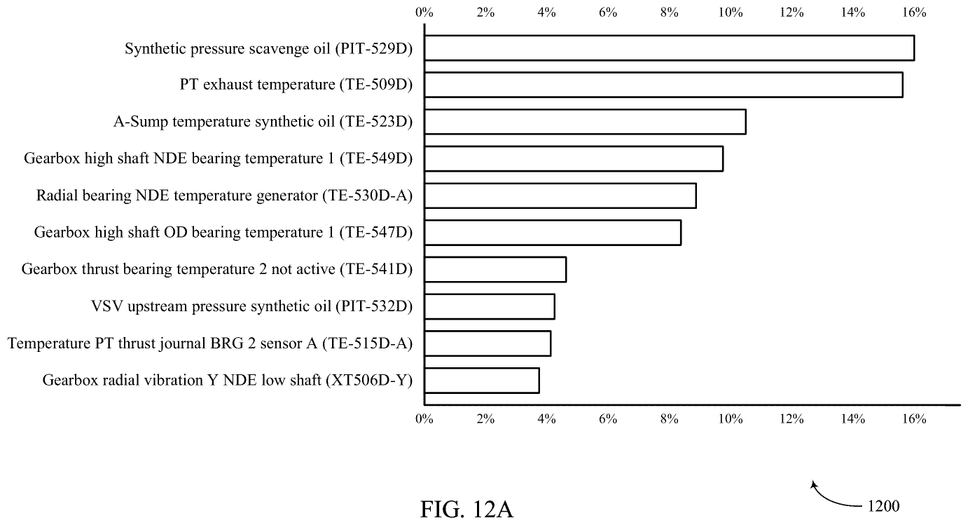

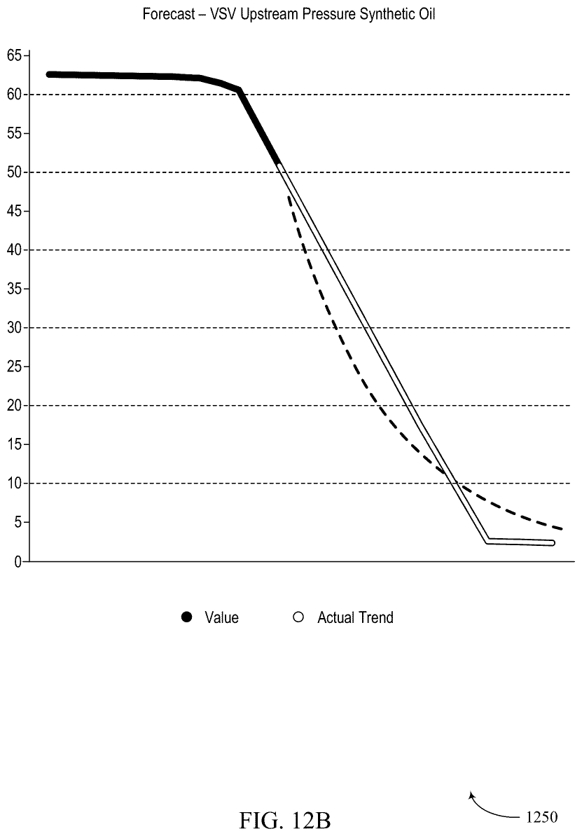

FIGS. 12A and 12B correspond to results obtained for a turbine used in a power generator of an oil refiner operation. The following criteria were used to define the status of the A3 turbine equipment: the equipment was considered “off” when: (a) fuel gas pressure (PIT-501D)<=0, (b) diesel pressure primary manifold (PIT-516D)<=0, (c) secondary manifold pressure diesel (PIT-517D)<=0, (d) XL vibration (VT-501D)<=5.

When the turbine was on, the model detected anomalies at a rate of 2.6% in a normal dataset and 7.3% in a test dataset. Using the anomaly detection model on a system with four “on” periods of three days or longer, 16.0% of anomalies that would lead to failure were detected within three days prior to the events and 39.5% within seven days prior to the events.

FIG. 12A shows the top features 1200 aggregating from the anomalies we detected in the turbine. Note that the top features contributing to anomalies may vary with time. FIG. 12B shows a graph 1250 illustrating the estimated time of failure for the PIT-532D: VSV upstream pressure synthetic oil, using feature forecasting as explained above. This was one of the top features that correlated to the system anomaly, as identified by the anomaly analysis model. As shown by the forecasting of this feature, the value is expected to reach a potential emergency shutdown threshold within 12 hours.

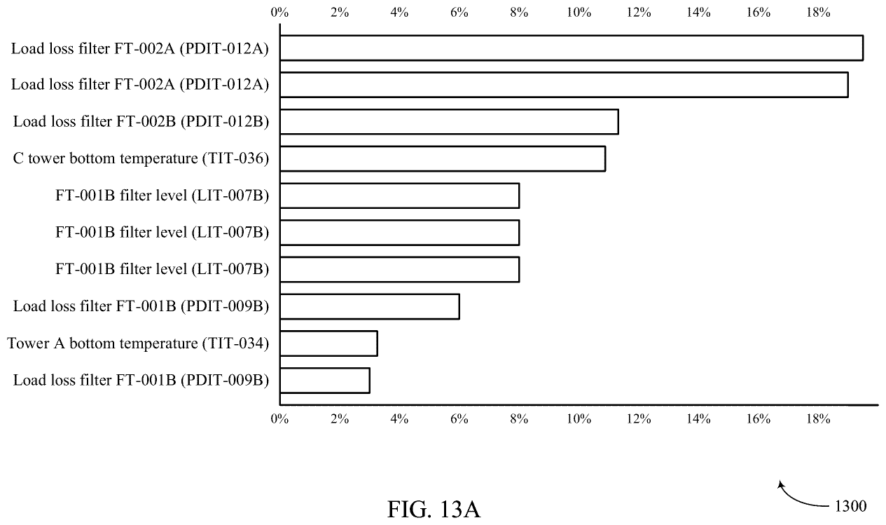

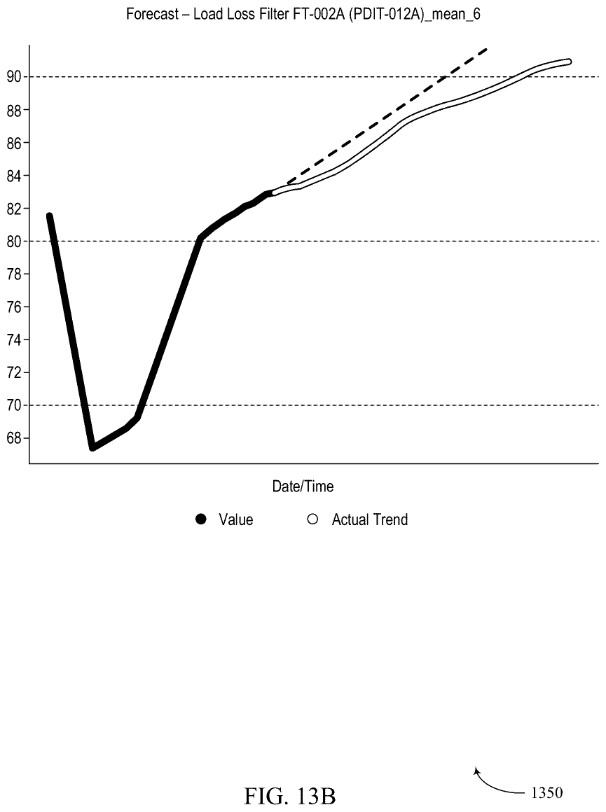

FIGS. 13A and 13B correspond to results obtained for a gas dehydrator used in an oil refinery operation. The following criteria was used to define the status of the A4 gas dehydrator dataset: the gas dehydrator was considered “off” if the FIT-001AB_SOMA (inlet gas flow of the unit)<=50.

When the gas dehydrator was on, the model detected anomalies at a rate of 4.5% in a normal dataset, 7.7% in a first test dataset, and 6.5% in a second test dataset. Using the anomaly detection model on a system with 14 “on” periods of three days or longer, 36.1% of anomalies that would lead to failure were detected within three days prior to the events and 55.1% within seven days prior to the events.

FIG. 13A shows the top features 1300 aggregating from the anomalies we detected in the gas dehydrator. Note that the top features contributing to anomalies may vary with time. FIG. 13B shows a graph 1350 illustrating the estimated time of failure for the PDIT-012A—Load Loss Filter (FT-002A), using feature forecasting as explained above. This was one of the top features that correlated to the system anomaly, as identified by the anomaly analysis model. As shown by the forecasting of this feature, the value is expected to reach a potential emergency shutdown threshold within 12 hours.

The embodiments disclosed in this disclosure are to help explain the concepts described herein. This description is not exhaustive and does not limit the claims to the precise embodiments disclosed. Modifications and variations from the exact embodiments in this disclosure may still be within the scope of the claims.

Likewise, the steps described need not be performed in the same sequence discussed or with the same degree of separation. Various steps may be omitted, repeated, combined, or divided, as appropriate. Accordingly, the present disclosure is not limited to the above-described embodiments, but instead is defined by the appended claims in light of their full scope of equivalents. In the above description and in the below claims, unless specified otherwise, the term “execute” and its variants are to be interpreted as pertaining to any operation of program code or instructions on a device, whether compiled, interpreted, or run using other techniques.

The claims that follow do not invoke section 112(f) unless the phrase “means for” is expressly used together with an associated function.

One or more specific embodiments of the present disclosure are described herein. These described embodiments are examples of the presently disclosed techniques. Additionally, in an effort to provide a concise description of these embodiments, not all features of an actual embodiment may be described in the specification. It should be appreciated that in the development of any such actual implementation, as in any engineering or design project, numerous embodiment-specific decisions will be made to achieve the developers' specific goals, such as compliance with system-related and business-related constraints, which may vary from one embodiment to another. Moreover, it should be appreciated that such a development effort might be complex and time consuming, but would nevertheless be a routine undertaking of design, fabrication, and manufacture for those of ordinary skill having the benefit of this disclosure.

The articles “a,” “an,” and “the” are intended to mean that there are one or more of the elements in the preceding descriptions. The terms “comprising,” “including,” and “having” are intended to be inclusive and mean that there may be additional elements other than the listed elements. Additionally, it should be understood that references to “one embodiment” or “an embodiment” or “one example” or “an example” of the present disclosure are not intended to be interpreted as excluding the existence of additional embodiments or examples that also incorporate the recited features. For example, any element described in relation to an embodiment or example herein may be combinable with any element of any other embodiment or example described herein. Numbers, percentages, ratios, or other values stated herein are intended to include that value and also other values that are “about” or “approximately” the stated value, as would be appreciated by one of ordinary skill in the art encompassed by embodiments of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

A person having ordinary skill in the art should realize in view of the present disclosure that equivalent constructions do not depart from the spirit and scope of the present disclosure, and that various changes, substitutions, and alterations may be made to embodiments disclosed herein without departing from the spirit and scope of the present disclosure. Equivalent constructions, including functional “means-plus-function” clauses are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words ‘means for’ appear together with an associated function. Each addition, deletion, and modification to the embodiments that falls within the meaning and scope of the claims is to be embraced by the claims.

The terms “approximately,” “about,” and “substantially” as used herein represent an amount close to the stated amount that still performs a desired function or achieves a desired result. For example, the terms “approximately,” “about,” and “substantially” may refer to an amount that is within less than 5% of, within less than 1% of, within less than 0.1% of, and within less than 0.01% of a stated amount. Further, it should be understood that any directions or reference frames in the preceding description are merely relative directions or movements. For example, any references to “up” and “down” or “above” or “below” are merely descriptive of the relative position or movement of the related elements.

The present disclosure may be embodied in other specific forms without departing from its spirit or characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

What is claimed is:

1. A computer-implemented method for protecting resources associated with petroleum-industry operations, at least a portion of the method being performed by a computing device comprising at least one processor, the method comprising:
constructing an anomaly detection model, comprising:
obtaining a feature set associated with failures of petroleum-industry operations;
determining, using unsupervised clustering or deep learning, system anomalies corresponding to the feature set, with an increased correlation to system failures of the petroleum-industry operations; and
applying fault mode analysis to the system anomalies.

2. The computer-implemented method of claim 1, further comprising performing a protective action to protect the resources associated with the petroleum-industry operations based on applying the anomaly detection model analysis.

3. The computer-implemented method of claim 1, wherein determining the system anomalies with an increased correlation to system failures comprises:
determining a system anomaly score for a system anomaly associated with a petroleum-industry operation; and
determining that the system anomaly score meets a threshold that when met, has an increased correlation to a system failure of the petroleum-industry operation,
wherein the method further comprises:
training the anomaly detection model to determine the threshold.

4. The computer-implemented method of claim 3, wherein determining the system anomalies with an increased correlation to system failures comprises determining individual anomaly scores for individual anomalies associated with the resources associated with the petroleum-industry operations, wherein the system anomaly scores are based on the individual anomaly scores.

5. The computer-implemented method of claim 4, wherein applying the fault mode analysis comprises determining which of the individual anomalies associated with the resources correlate to the system anomalies.

6. The computer-implemented method of claim 1, further comprising determining estimated times to failure associated with the system anomalies based on the fault mode analysis.

7. A computer-implemented method for protecting resources associated with petroleum-industry operations, at least a portion of the method being performed by a computing device comprising at least one processor, the method comprising:
monitoring data associated with resources associated with a petroleum-industry operation;
detecting a system anomaly with an increased correlation to a system failure of the petroleum-industry operation, based on the monitored data, using machine learning; and
performing a protective action to protect the resources associated with the petroleum-industry operation, based on detecting the system anomaly.

8. The computer-implemented method of claim 7, wherein the system anomaly is detected using unsupervised clustering or deep learning autoencoding applied to the monitored data.

9. The computer-implemented method of claim 7, further comprising:
determining a cause of the system anomaly after detecting the system anomaly, wherein performing the protective action is based on determining the cause of the system anomaly.

10. The computer-implemented method of claim 7, further comprising:
determining, after detecting the system anomaly, a length of time until the system failure of the petroleum-industry operation is estimated to occur, using machine learning.

11. The computer-implemented method of claim 10, further comprising:
determining, after detecting the system anomaly, which of the resources associated with the petroleum-industry operation correlate to the system anomaly; and
determining individual estimated times to failure for the resources that correlate to the system anomaly, wherein the length of time until the system failure is estimated to occur is based on the individual estimated times to failure.

12. The computer-implemented method of claim 10, wherein performing the protective action is based on the length of time until the system failure is estimated to occur being less than a length of time that the petroleum-industry operation is scheduled to be performed.

13. The computer-implemented method of claim 7, further comprising:
determining a system anomaly score for the system anomaly based on the monitored data,
wherein detecting the system anomaly comprises determining that the system anomaly score meets a threshold.

14. The computer-implemented method of claim 13, further comprising:
determining individual anomaly scores for individual anomalies associated with the resources based on the monitored data, wherein the system anomaly score is based on the individual anomaly scores.

15. The computer-implemented method of claim 13, further comprising:
determining individual anomaly scores for individual anomalies associated with the resources associated with the petroleum-industry operation based on the monitored data; and
determining, after detecting the system anomaly, which of the resources correlate to the system anomaly based on the individual anomaly scores.

16. The computer-implemented method of claim 15, further comprising:
determining estimated individual times to failure for the resources that correlate to the system anomaly; and
determining an estimated system time to failure based on the estimated individual times to failure.

17. The computer-implemented method of claim 16, wherein determining the estimated system time to failure comprises determining that the estimated system time to failure is the shortest of the estimated individual times to failure.

18. The computer-implemented method of claim 7, wherein performing the protective action comprises shutting down equipment associated with the petroleum-industry operation.

19. The computer-implemented method of claim 7, wherein performing the protective action comprises providing a warning to an operator.

20. A computer-implemented method for protecting resources associated with petroleum-industry operations, at least a portion of the method being performed by a computing device comprising at least one processor, the method comprising:
monitoring data associated with a plurality of resources associated with a petroleum-industry operation;
detecting a system anomaly associated with the petroleum-industry operation based on the monitored data;
determining a subset of the plurality of resources that correlate to the system anomaly;
determining, for each of one or more resources of the subset of the plurality of resources, an estimated time to failure associated with the resource;
determining a length of time until system failure of the petroleum-industry operation is estimated to occur, based on the estimated times to failure associated with the one or more resources; and
performing a protective action to protect the plurality of resources associated with the petroleum-industry operation, based on determining the length of time until system failure of the petroleum-industry operation is estimated to occur.
